(19) United States
(12) Patent Application Publication
(10) Pub. No.: US 2017/0102874 A1
(43) Pub. Date: Apr. 13, 2017

(54) COMPUTER SYSTEM

(71) Applicant: HITACHI, LTD., Tokyo (JP)

(72) Inventors: Katsumi OUCHI, Tokyo (JP); Ai SATOYAMA, Tokyo (JP); Yoshiaki EGUCHI, Tokyo (JP)

(73) Assignee: HITACHI, LTD., Tokyo (JP)

(21) Appl. No.: 15/125,204

(22) PCT Filed: Jun. 20, 2014
(86) PCT No.: PCT/JP2014/066419

§ 371 Date: Sep. 12, 2016

(51) Int. Cl. G06F 3/06; G06F 13/42

(52) U.S. Cl. CPC G06F 3/061; G06F 13/4282; G06F 3/0679; G06F 3/0655; G06F 3/0631; G06F 2213/0026

(57) ABSTRACT

A plurality of server computers shares a virtualized namespace. A storage controller provides a virtual storage area shared by a first server computer and a second server computer. A server computer that is each of the first server computer and the second server computer stores a program that issues an NVM-Express command that is a command conforming to an NVM-Express standard. The program allows the server computer to access the virtual storage area via the PCI-Express by issuing the NVM-Express command specifying a namespace associated with the virtual storage area. The storage controller allocates a storage area in a nonvolatile memory device to the virtual storage area based on the access.

The present invention relates to a computer system including a nonvolatile memory device.

### BACKGROUND ART

Flash memory devices (hereinafter referred to as flashes) provide higher I/O (Input/Output) performance than HDDs (Hard Disk Drives). However, in connection with provision of the performance of the flash memory device, conventional SCSI (Small Computer System Interfaces) involves inefficient processing executed in a server by programs such as an OS (Operating System) and device drivers. Thus, providing the high I/O performance of the flash memory device is not easy. NVM-Express (Non-Volatile Memory Express; hereinafter abbreviated as NVMe) described in PTL1 is a standard that specifies the following in order to solve the above-described problem.

This specification defines a streamlined set of registers whose functionality includes:
Indication of controller capabilities
Status for controller failures (command status is processed via CQ directly)
Admin Queue configuration (I/O Queue configuration processed via Admin commands)
Doorbell registers for scalable number of Submission and Completion Queues

Key points for NVMe are as follows.
Does not require uncacheable/MMIO register reads in the command submission or completion path.
A maximum of one MMIO register write is necessary in the command submission path.
Support for up to 65,535 I/O queues, with each I/O queue supporting up to 64K outstanding commands.
Priority associated with each I/O queue with well-defined arbitration mechanism.
All information to complete a 4 KB read request is included in the 64 B command itself, ensuring efficient small I/O operation.
Efficient and streamlined command set.
Support for MSI/MSI-X and interrupt aggregation.
Support for multiple namespaces.
Efficient support for I/O virtualization architectures like SR-IOV.
Robust error reporting and management capabilities.
Support for multi-path I/O and namespace sharing.

Furthermore, NPL 1 discloses the concept that a namespace (hereinafter abbreviated as an NS) is shared by a plurality of hosts.

NPL 2 discloses that the I/O performance of the server is improved by using a PCI-Express flash memory SSD (Solid State Drive) that interprets commands conforming to NVMe as described above (hereinafter PCI-Express will be abbreviated as PCIe).

Capacity virtualization (thin provisioning) is known as a technique for improving utilization efficiency of storage. In the capacity virtualization, the capacity of a virtual storage area is made to appear to the server to be larger than the capacity of an actual storage area, and the actual storage area is allocated to the virtual storage area according to the amount of stored data.

Furthermore, tier control virtualization is known as a technique for improving a performance/cost ratio of storage. In the tier control virtualization, frequently accessed data is automatically stored in a high-speed storage tier, and infrequently accessed data is automatically stored in a storage tier with a low bit cost. This reduces tier management burdens on storage administrator.

NVMe is an interface that reduces a latency in access from the server to a flash memory. In the NVMe, a main access target is a flash memory on a PCIe add-on card in the server.

NPL 1 discloses thin provisioning for a namespace that is a storage area. The server can acquire the status of the thin provisioning by issuing an Identify command specified in the NVMe to the storage.

### CITATION LIST

### Non Patent Literature

[NPL 1]

“NVM Express 1.1a Specification,” http://www.nvmexpress.org/wp-content/uploads/NVM-Express-1_1a.pdf

[NPL 2]

“NVM Express: Unlock Your Solid State Drives Potential,” http://www.nvmexpress.org/wp-content/uploads/2013-FMS-NVMe-Track.pdf

### SUMMARY OF INVENTION

### Technical Problem

The NVMe standard disclosed in NPL 1 discloses the concept of NS sharing, but fails to disclose an implementation as described below.

Providing a computer system that implements high-performance I/O is not easy.

“1.3 Outside of Scope

The register interface and command set are specified apart from any usage model for the NVM, but rather only specifies the communication interface to the NVM subsystem. Thus, this specification does not specify whether the non-volatile memory system is used as a solid state drive, a main memory, a cache memory, a backup memory, a redundant memory, etc. Specific usage models are outside the scope, optional, and not licensed.”

Furthermore, the specification of the NVMe does not disclose a method for implementing virtualization of a namespace. Thus, sharing a virtualized namespace is not easy.

### Solution to Problem

To solve the above-described problem, a computer system includes a first server computer, a second server computer, a nonvolatile memory device, and a storage controller connected to the first server computer and the second server computer via PCI-Express, and connected to the nonvolatile memory device. The storage controller provides a virtual storage area shared by the first server computer and the second server computer. A server computer that is each of the first server computer and the second server computer stores a program that issues an NVM-Express command that is a command conforming to an NVM-Express standard. The program allows the server computer to access the virtual storage area via the PCI-Express by issuing the NVM-Express command specifying a namespace associated with the virtual storage area. The storage controller allocates a storage area in the nonvolatile memory device to the virtual storage area based on the access.

### BRIEF DESCRIPTION OF DRAWINGS

FIG. 1 is a diagram depicting a summary of an embodiment.

FIG. 2 is a diagram depicting a physical configuration and a logical configuration of a CPF.

FIG. 3 is a diagram depicting a physical configuration and a logical configuration of another CPF.

FIG. 4 is a diagram depicting details of the CPF in which an NVMe interpretation section is a candidate (3).

FIG. 5 is a diagram depicting a PCIe space in a server-side PCIe I/F device.

FIG. 6 is a diagram depicting a relation between NVMe NSs and storage areas in a storage controller.

FIG. 7 is a flowchart depicting a process related to an NVMe command.

FIG. 8 is a flowchart depicting a method for booting the CPF.

FIG. 9 is a diagram depicting details of the CPF in which the NVMe interpretation section is a candidate (2).

FIG. 10 is a diagram depicting an example of an application of the CPF.

FIG. 11 is a diagram depicting a configuration of data in a storage controller 3.

FIG. 12 is a diagram depicting an LU management table 351.

FIG. 13 is a diagram depicting a virtual-volume management table 352.

FIG. 14 is a diagram depicting a pool management table 353.

FIG. 15 is a diagram depicting a logical-volume management table 354.

FIG. 16 is a diagram depicting a virtual-volume creation process.

FIG. 17 is a diagram depicting a virtual-volume creation screen.

FIG. 18 is a diagram depicting logical-volume registration process.

FIG. 19 is a diagram depicting a write process executed on a virtual volume.

FIG. 20 is a diagram depicting an NVMe command response process.

FIG. 21 is a diagram depicting a relation between a response to an Identify command and a storage capacity.

FIG. 22 is a diagram depicting an inquiry process.

FIG. 23 is a diagram depicting a virtual-volume management table 352b for a case where thin provisioning is applied with tiering not applied.

FIG. 24 is a diagram depicting a pool management table 353b for the case where the thin provisioning is applied with the tiering not applied.

FIG. 25 is a diagram depicting a logical-volume management table 354b for the case where the thin provisioning is applied with the tiering not applied.

FIG. 26 is a diagram depicting a virtual-volume creation screen for the case where the thin provisioning is applied with the tiering not applied.

FIG. 27 is a diagram depicting the relation between the response to the Identify command and the storage capacity for a case where the thin provisioning is not applied.

FIG. 28 is an LU management table 351c for a case where the tiering is applied with the thin provisioning not applied.

### DESCRIPTION OF EMBODIMENTS

An embodiment will be described below with reference to the drawings. However, the present embodiment is only an example of implementation of the invention and is not intended to limit the technical scope of the invention. Furthermore, components common to the drawings are denoted by the same reference numerals.

Information in the present embodiment will be described using an expression “table”. However, the information need not necessarily be expressed in a data structure based on a table. For example, the information may be expressed in a data structure such as a “list”, a “DB (Database)”, or a “queue” or using any other structure. Thus, to indicate independence of the data structure, the “table”, the “list”, the “DB”, the “queue”, and the like may be simply referred to as “information”. Furthermore, when the contents of each type of information are described, expressions “identity”, “identifier”, “name”, and “ID” may be used and are interchangeable.

The subject in the description below is a “program”. However, the subject in the description may be a CPU (Central Processing Unit) because the program is executed by the CPU to execute a defined process using a memory and a communication port (communication control apparatus). Furthermore, processes disclosed using a program as the subject may be processes executed by a computer such as a server computer, a storage computer, or a management computer, or an information processing apparatus. Some or all of the programs may be realized by dedicated hardware or modularized. The various programs maybe installed in each computer via a program distribution server or storage media.

### Summary of the Embodiment

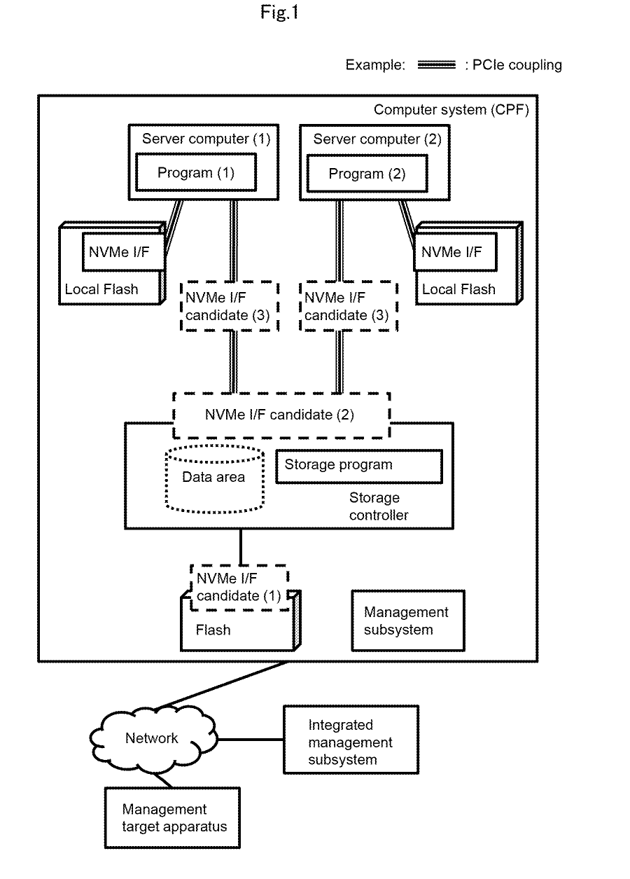

FIG. 1 depicts a summary of the present embodiment. The description below is applicable to succeeding standards for NVMe which will emerge in the future and similarly to succeeding standards for PCI-Express (Peripheral Component Interconnect Express; hereinafter abbreviated as PCIe). When a term related to NVMe or PCIe is used, the term may be considered to indicate an equivalent term for succeeding standards for NVMe or PCIe. Similarly, the description of the embodiment is intended for NVMe targeted for block accesses. However, of course, if accesses in bytes or words are specified in the NVMe standard, the present embodiment is applicable to those accesses. Similarly, the description of the present embodiment is intended for a nonvolatile memory device using a flash memory, but the present embodiment is applicable to nonvolatile memories other than flash memories, for example, nonvolatile memory devices using FeRAM (Ferroelectric Random Access Memory), MRAM (Magnetoresistive Random Access Memory), phase change memory (Ovonic Unified Memory), or RRAM® (Resistance RAM).

<<NVMe>>

As described in NPL 1 and NPL 2, NVMe is an I/F (Interface) standard for implementing high-speed accesses to a flash memory SSD. Developing programs (including, for example, device drivers, applications, and OSs) in accordance with the NVMe standard enables high-speed accesses to the flash memory SSD involving high IOPS (Input/Output per Second) and low latency. For example, NPL 2 discloses, in page 18, that an access latency of 6.0 μs measured in an SSD adopted for SCSI/SASs (Serial Attached SCSIs) can be reduced to 2.8 μs by adopting NVMe. The key points for the reduction are as described above. NVMe uses multi I/O queues to avoid sharing of one I/O queue among a plurality of cores, allowing improvement of the efficiency of memory accesses among CPU cores.

NVMe is expected to be standardized so that a variety of flash memory devices conform to the NVMe standard. Thus, venders of programs other than device drivers (typically application programs) can expect the vender's programs to directly issue an NVMe command to access a flash memory device.

The “flash memory device” in the present embodiment has at least the following features. A flash memory SSD is an example of such a flash memory device:
The flash memory device includes a flash memory chip.
The flash memory device includes a flash memory controller that executes the following processes:
   The flash memory controller transfers data saved in the flash memory chip to the outside in accordance with an external read request. The flash memory controller saves data received along with the externally received write request to the flash memory chip.
   The flash memory controller executes an erase process of the flash memory chip.

<<Computer System>>

The computer system at least includes one or more server computers, one or more storage controllers, a flash memory device (which may be abbreviated as “Flash” in the figures), and a communication mechanism. The contents of the computer system may each be referred to as a computer system component.

The present computer system is preferably a converged platform. The converged platform is also referred to as a converged infrastructure or a converged system. In Japanese, “converged” maybe replaced with “vertical integration”. In the present embodiment, these will be collectively referred to as converged platforms (which may be abbreviated as CPFs). The CPF has the following features:
Products including a server computer, a storage system (including a storage controller and a storage device), and a communication mechanism that connects the server computer and the storage system together. Upon individually introducing a server computer and a storage system into a company, a manager of the company performs operation verification represented by a check on the connection between the server computer and the storage system. However, when introducing the CPF, because vendors sell the products pre-perform the operation verification, it achieves elimination or reduction of the need for a manager of a client that installs and uses the products to perform the operation verification.
Some CPFs include a management subsystem executing a management program that collectively configures the server computer, the storage system, and the communication mechanism. The management subsystem can quickly provide an execution environment (a virtual machine, a DBMS: Database Management System, a Web server, or the like) desired by the manager. For example, to provide a virtual machine with needed amounts of resources, the management program requests the server computer and the storage system to allocate needed resources for the virtual machine and requests a hypervisor to create the virtual machine using the allocated resources.

<<Server Computer>>

Server computers (1) and (2) are units storing and executing programs (1) and (2), respectively, which access the storage controller. The programs (1) and (2) issue an NVMe command to access a shared data area provided by the storage controller. Parts of the shared data area which are provided as NVMe NSs will be described.

The server computer at least includes a CPU, a main memory (hereinafter abbreviated as a memory), and an RC. The server computer may be, for example, as follows:
File server
Blade server system
PC (Personal Computer) server
Blade inserted into the blade server system

<<Programs for the Server Computer>>

The programs (1) and (2) are, for example, business application programs (for example, Web servers, DBMSs, analysis programs, or middleware), programs that enable LPAR (Logical Partitioning) or a virtual machine to be created, OSs, or device drivers or maybe other programs.

<<Communication Mechanism>>

The communication mechanism connects the server computer and the storage controller based on PCIe. The PCIe connection between the server computer and the storage controller involves no network such as an FC (Fiber Channel) or an SAN (Storage Area Network) using Ethernet® which is adopted for a conventional connection between a server computer and a storage system. The reasons are as follows (one or both of the reasons):
A protocol that enables such a wide-area SAN to be constructed has high overhead in conversion processes, hindering provision of high-performance inputs to and outputs from the shared data area.
Devices (particularly switches) for Ethernet and the SAN are expensive.

NVMe assumes the communication mechanism based on PCIe. Thus, a section of the server computer that interprets NVMe commands needs to be an endpoint (hereinafter abbreviated as an EP) in accordance with PCIe. Furthermore, if a PCIe chip set does not permit a plurality of root complexes (hereinafter abbreviated as RCs) to share an EP (this is hereinafter referred to as “coexistence of a plurality of RCs”) (for example, if the PCIe chip set does not support MR-IOV: Multi-Root I/O Virtualization), this limitation needs to be taken into account.

Based on the above description, the present embodiment discloses three candidates for the section that interprets NVMe commands. The computer system may include one of the three candidates. The three candidates (1), (2), and (3) (represented as NVMe I/F candidates (1), (2), and (3) in the figures) are as follows:
Candidate (1) : The flash memory device. In this case, the storage controller and the flash memory device are connected together based on PCIe, and the flash memory device serves as an EP with functions conforming to NVMe. The storage controller passes an NVMe command from the server computer to the flash memory device.
Candidate (2): The storage controller. In this case, the storage controller and the flash memory device are connected together based on PCIe. If the coexistence of a plurality of RCs is limited, the PCIe connection between an RC in the server computer (1) and an RC in the storage controller is separated from the PCIe connection between an RC in the server computer (2) and the RC in the storage controller. The RC in the storage controller provides individual endpoints to the RCs in the respective server computers.
Candidate (3): An intermediate device that intermediates between a PCIe connection from the server computer and a PCIe connection from the storage controller. Because CPUs and PCIe chip sets provided by Intel® and AMD® are commoditized, these are inexpensive and deliver high performance. A possible problem with the adoption of such a CPU or a PCIe chip set is that the RC is also present in the storage controller to prevent a direct connection between the server computer and the storage controller when the coexistence of a plurality of RCs is limited as described above. The intermediate device solves this problem by including a logic that provides an endpoint to the RC in each of the server computers, a logic that provides another EP to the RC in the storage controller, and a logic that intermediates transfer of write data and read data between the server computer and the storage controller.

Because PCIe has been widely used as a communication path inside the server computer and inside the storage controller, it achieves a shorter communication enabled distance than FC and Ethernet, and the number of EPs that can communicate with the RC is smaller than the number of communication nodes that can communicate using FC or Ethernet. Furthermore, PCIe achieves only weaker failure management than communication protocols operating on FC and Ethernet. Thus, the present computer system adopting PCIe as a communication mechanism is preferably a CPF. Treating the computer system as the CPF eliminates the need for cabling of the communication mechanism among the server computer and the storage unit so that it suppress trouble associated with the above-described disadvantages of PCIe, and allowing reliable NVMe accesses to be provided.

<<Advantages of Each NVMe Command Interpretation Section>>

The candidates (1) to (3) for the section that interprets NVMe commands have, for example, the following advantages.
Candidate (1): Processing executed by the storage controller has no or low overhead. The candidate (1) is easy to realize efficient NVMe queue control with taking the internal status of the flash memory device into account. This is because the section that interprets NVMe commands is the same as or close to a controller that performs wear leveling, reclamation, and the like for the flash memory device. For example, a plurality of I/O queues is present in accordance with NVMe, the candidate (1) changes a manner of retrieving NVMe commands from a plurality of I/O queues based on the internal status.
Candidate (2): Enterprise functions provided by the storage controller can be applied to the NVMe NSs. Furthermore, the candidate (2) can perform efficient NVMe queue control taking the internal status of the storage controller into account. This is because the section that interprets NVMe commands is the same as or close to the storage controller. For example, the candidate (2) can change a manner of retrieving NVMe commands from a plurality of I/O queues based on the internal status, and further can change control of other processes executed by the storage controller based on an accumulation state of NVMe commands in the I/O queues.
Candidate (3): Enterprise functions provided by the storage controller can be applied to the NVMe NSs. Furthermore, if the intermediate device as the candidate (3) converts an NVMe command into a SCSI request (SCSI command), storage programs executed by the storage controller easily remain compatibility with storage programs in a conventional SAN storage subsystem at the level of execution code, intermediate code, or source code. This allows an improvement of the quality and functions of the storage programs in the computer system, and facilitates implementation of cooperative processing between the storage controller of the computer system and the SAN storage subsystem such as the remote copying. This is because the cooperative processing is mostly the same as the normal cooperation between the SAN storage subsystems.

<<Storage Controller>>

The storage controller uses a storage area in the flash memory device to provide high-performance I/O processing. Furthermore, the storage controller may have functions related to such reliability, redundancy, functionality, and maintainability and manageability as provided by enterprise SAN subsystems. Examples are as follows:
The storage controller makes the flash memory device redundant and provides a shared data area from the redundant storage area. Furthermore, the storage controller enables device maintenance such as replacement, expansion, and removal of the flash memory device without the need to inhibit accesses to the data stored in the shared data area or to force the accesses to fail (what is called non-stop). Unlike HDDs, the flash memory device is characterized in that device lifetime is shortened by excessive write to the device. Thus, the storage controller provides such redundancy and non-stop maintenance so that the reliability of the present computer system is improved. Additionally, when a PCIe flash memory device is inserted into the server computer, the maintenance of the flash memory device needs to be individually performed on the respective server computers. However, when the flash memory device is connected to the storage controller as is the case with the present computer system to concentrate the maintenance of the storage controller on the storage side, a maintenance operator can collectively perform maintenance work on the flash memory device and easily carry out maintenance.
The storage controller provides copy functions such as remote copying and snapshot for data stored based on NVMe.
The storage controller is connected to an HDD as s storage device besides the flash memory device to enable tiering using the storage device. The storage controller may associate the storage area provided by the HDD with the NVMe NSs.
The storage controller provides accesses from a computer system (including a server computer and a storage controller) outside the present computer system or accesses from a network apparatus (including a SAN switch or an Ethernet switch) via a network, without via the server computer (1) or (2). This leads to improved flexibility, such as enabling of the above-described remote copying and provision of storage consolidation including the computer system or the network apparatus, which are outside the present computer system.

<<Arrangement of the Server Computer and the Storage Controller>>

As described above, the communicable distance of PCIe is short, the server computer and the storage controller may be arranged at physically close positions. However, the following configuration is more preferable:
The storage controller is configured to be inserted into a chassis of the blade server system. When a substrate such as a backplane is used for a PCIe connection between the storage controller and a blade that is the server computer, trouble associated with the PCIe connection can be reduced.
The storage controller is placed in a chassis different from the chassis of the blade server system. Both chassis are connected together via a cable for PCIe connections. One rack, in which the chassis of the blade server system and the chassis of the storage controller are placed, may be sold as a CPF. Such manner, placing both chassis and the cable for PCIe connection in the rack, enables a reduction in trouble associated with the cable for PCIe connection, and makes it easy to divert the chassis itself of the blade server system or the storage system sold alone or a component of the blade server system or the storage system sold alone.

<<Management Subsystem>>

The management subsystem executes at least one of the following processes:
Receiving a request from an administrator or an integrated management subsystem and configuring computer system components in accordance with the request.
Acquiring information from the computer system components and displaying the information to the administrator or transmitting the information to the integrated management subsystem. The acquired information includes, for example, performance information, fault information, setting information, and configuration information. For example, the configuration information includes items fixed to the present computer system unless the components are removed from and then installed in the computer system, and changeable items. The setting information is a changeable item in the configuration information by the configuration (i.e. setting). These types of information may be collectively referred to as component information. Furthermore, the information displayed to the administrator or transmitted to another computer may be the acquired component information itself or may be converted or processed based on certain criteria before the display or transmission of the information.
What is called automatic and autonomous management in which the management subsystem automatically and autonomously configures the computer system components based on the component information.

The management subsystem may be in one or mixture of the following forms. However, the management subsystem is not limited to these forms and may be in any form in which the management subsystem executes the above-described processes. A set of relevant functions and computers corresponds to the management subsystem.
One or more computers different from the computer system components. If the management subsystem corresponds to a plurality of computers connected to the computer system via a network, a computer exclusively used as a server computer, a computer exclusively used as a storage controller, and a computer exclusively used for a display process may be present in the management subsystem, for example.
Some of the computer system components. For example, a BMC (Baseboard Management Controller) and an agent program correspond to the management subsystem.

<<Integrated Management Subsystem>>

The integrated management subsystem is a subsystem that integrally manages management target apparatuses typified by the server, the storage system, the network apparatus (including an SAN switch or an Ethernet switch), and the present computer system. The integrated management subsystem is connected to the management subsystem and the other management target apparatuses via the network. The integrated management subsystem may communicate with any of the management target apparatuses in accordance with a vender-proprietary protocol in order to manage the plurality of management target apparatuses or may communicate in accordance with a standardized protocol such as SNMP (Simple Network Management Protocol) or SMI-S (Storage Management Initiative-Specification).

The integrated management subsystem includes one or more computers connected to the computer system via the network.

A vendor providing the integrated management subsystem may be different from the vendor of the present computer system. Since the communication mechanism of the present computer system is a PCIe communication mechanism, in that case, the integrated management subsystem may fail to manage the present computer system, or even if the integrated management subsystem can manage the present computer system, the management may be inferior to the normal management. An example of the reason is that the integrated management subsystem may exclusively recognize an FC or Ethernet connection as the connection path between the server computer and the shared storage controller and fail to recognize a PCIe connection as the connection path. In this case, the integrated management subsystem does not consider the server computer and the shared storage controller to be connected together, but consider that each server computer treat the shared storage controller as the local flash memory device. Thus, management items assuming the presence of such connection information are not applicable to the present computer system.

For measures against such a case, the management subsystem of the present computer system may cause the PCIe connection of the present computer system to emulate an SAN connection. The management subsystem thus may converts information on the PCIe connection into information on the virtual SAN connection and transmits the information on the SAN connection to the integrated management subsystem. Then, the integrated management subsystem may consider the SAN connection to be a management target. The emulation of the SAN connection may be, for example, provision of connection information or acceptance of configuration for the SAN connection (allocation of logical units to storage ports). The SAN to be emulated may be an FC-SAN, an IP (Internet Protocol)-SAN, or an Ethernet-SAN.

<<Applications of the Present Computer System and Combined Use of a Local Flash Memory Device>>

As described above, the present computer system may be introduced in order to realize data sharing among a plurality of server computers based on NVMe. Or, the present computer system may be introduced in order to apply enterprise functions provided by the above-described storage controller to data stored based on NVMe, without the data sharing. Or, if a business system has already been constructed using a program that issues NVMe commands in an environment different from the present computer system, the present computer system may be able to construct the business system, without implementing an interface for a vender-proprietary flash memory device to the program.

The data sharing based on NVMe has, for example, the following uses:
High-speed fail-over among a plurality of server computers. In response to a fault of the server computer (1) or the like, the server computer (2) determines to perform fail-over to take over processing executed by the server computer (1). If each of the plurality of server computers is connected to local flash memories (abbreviated as “Local flashes” in the figures) via a PCIe connection, and a destination of NVMe commands issued by the programs in the server computer is only to the local flash memory devices, the plurality of server computers needs to copy data between a fail-over source local flash memory device and a fail-over destination local flash memory device. This makes high-speed fail-over difficult. The present computer system does not need such data copying.
A case where a plurality of server computers executes parallel processing by accessing the shared data area in parallel based on NVMe. A certain server computer writes data, and then, another server computer can read the data immediately.

However, when the number of server computers increases, the I/O processing capability of the storage controller maybe a bottleneck.

For measures against such a case, each of the server computers may be connected to a flash memory device that can interpret NVMe commands (which is referred to as a local flash memory device) based on PCIe, and such local flash memory device may be occupied by the connected server computer. In such a configuration, the program executed by the server computer, may store un-sharing data or data unneeded to apply enterprise functions, in the local flash memory devices, and the program may store data to be shared or data needed to apply enterprise functions, in the NVMe NSs being storage areas provided by the storage controller. For example, in a configuration in which the server computer (2) takes over processing executed by the programs in the server computer (1) as a result of, for example, a fault in or a load on the server computer (1), the server computer (1) executes processing, by writing data needed for the takeover to the NSs being the shared data area and reading the data from the NSs, and writes data unneeded for the takeover to the local flash memory device.

Such configuration may be manually performed but may be automatically carried out by the above-described management subsystem or the integrated management subsystem. For example, these subsystem may be configured to determine whether or not each of the NSs can be shared by a plurality of server computers (or enterprise functions can be applied to the NS), to determine data that need to be shared (or to which the enterprise functions need to be applied) based on a characteristic of programs executed by the server computers, and to configure the programs executed by the server computers for using properly the storage area to store data of the program. Because the administrator for the programs does not necessarily know the configuration and features of the present computer system well, administrator' s workload of configuration of the programs is reduced. A method for determining whether or not the NS can be shared is as follows, but any other method may be used:
The management subsystem inquires to the computer system of the relations between NSIDs and the storage areas of the storage controller.
Whether the NS can be shared by the server computers is determined based on information obtained by a program in the server computer by specifying the NSIDs to collect information.

<Basic Configuration Diagram>

A further detailed embodiment will be described taking, as an example, a case where the computer system is a CPF.

<<CPF Under NVMe Control>>

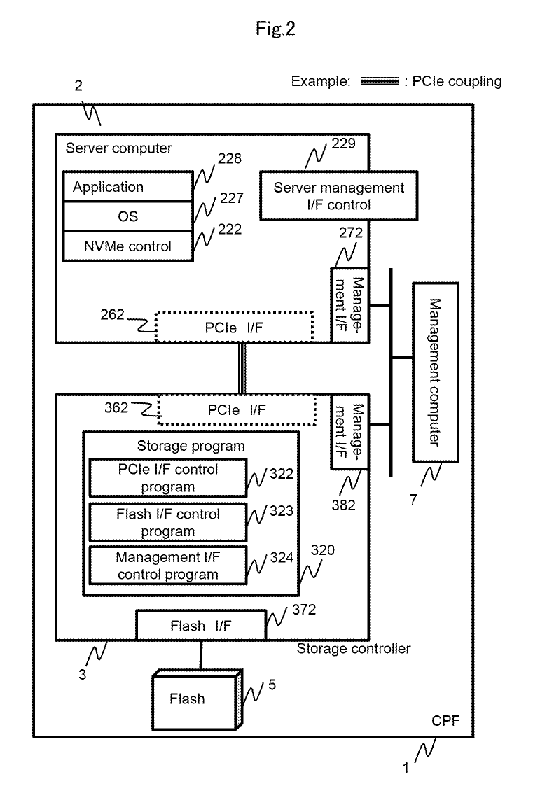

FIG. 2 is a diagram depicting a physical configuration and a logical configuration of the CPF.

The CPF 1 in FIG. 2 includes a server computer 2, a storage controller 3, a flash memory device 5 serving as a storage device, and a management computer 7 that is an example of the management subsystem.

The server computer 2 includes a management I/F 272 for connection to the management computer 7. The server computer 2 executes an application program 228 (which may be simply abbreviated as an application), an OS 227, an NVMe control program 222, and a server management I/F control program 229 that are examples of the programs. The connection between the management computer 7, the server computer 2 and the storage controller 3 is expected to be based on Ethernet but may be in any other physical or virtual connection form. The server management I/F control program 229 controls the management I/F 272 to communicate with the management computer 7.

The NVMe control program 222 is a program that issues NVMe commands to a PCIe I/F 262. The program 222 may be a part of other program stored in the server computer 2 or a program different from the other program stored in the server computer 2. For example, the application program 228 may issue NVMe commands or device drivers in the OS 227 may issue NVMe commands.

The PCIe I/F 262 transmits an NVMe command to a PCIe I/F 362 in accordance with operation of the NVMe control program 222, and then receives a response to the NVMe command from the PCIe I/F 362. The PCIe I/F 262 returns the response to the NVMe control program 222.

The storage controller 3 includes a management I/F 382 for connection to the management computer 7 and a flash I/F 372 for connection to the flash memory device 5. The connection between the flash I/F 372 and the flash memory device 5 is preferably a PCIe connection if the flash memory device 5 interprets NVMe commands. Otherwise, the connection may be based on SAS, SATA (Serial Advanced Technology Attachment), FC, or Ethernet or any other communication mechanism may be used.

The storage controller 3 executes a storage program 320. The storage program 320 includes, for example, a PCIe I/F control program 322, a flash I/F control program 323, and a management I/F control program 324 that control communications with the respective interfaces. The PCIe I/F control program 322 controls the PCIe I/F 362 to communicate with the server computer 2. The flash I/F control program 323 controls the flash I/F 372 to communicate with the flash memory device 5. The management I/F control program 324 controls the management I/F 382 to communicate with the management computer 7.

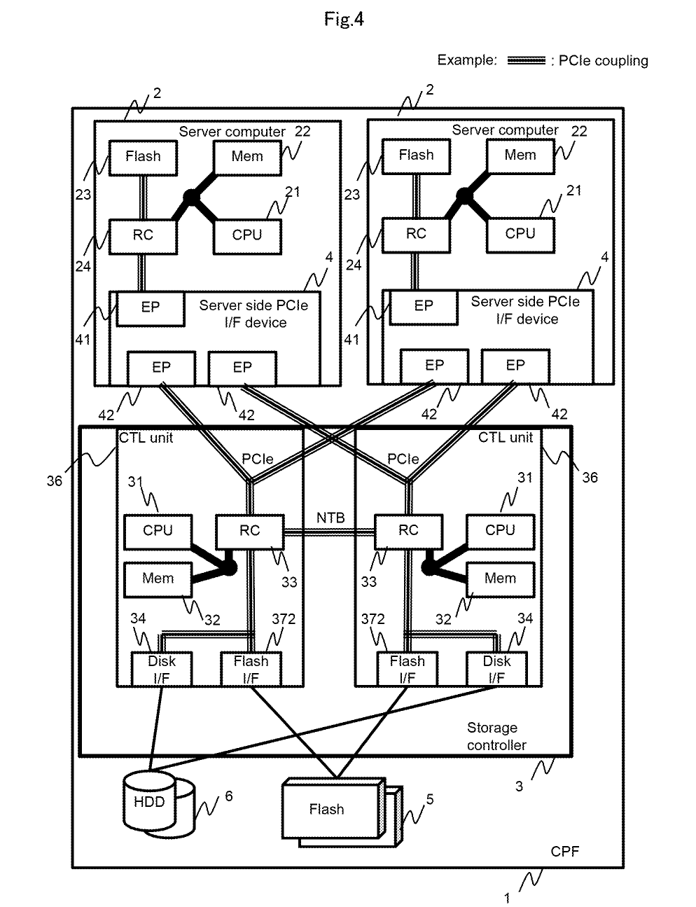

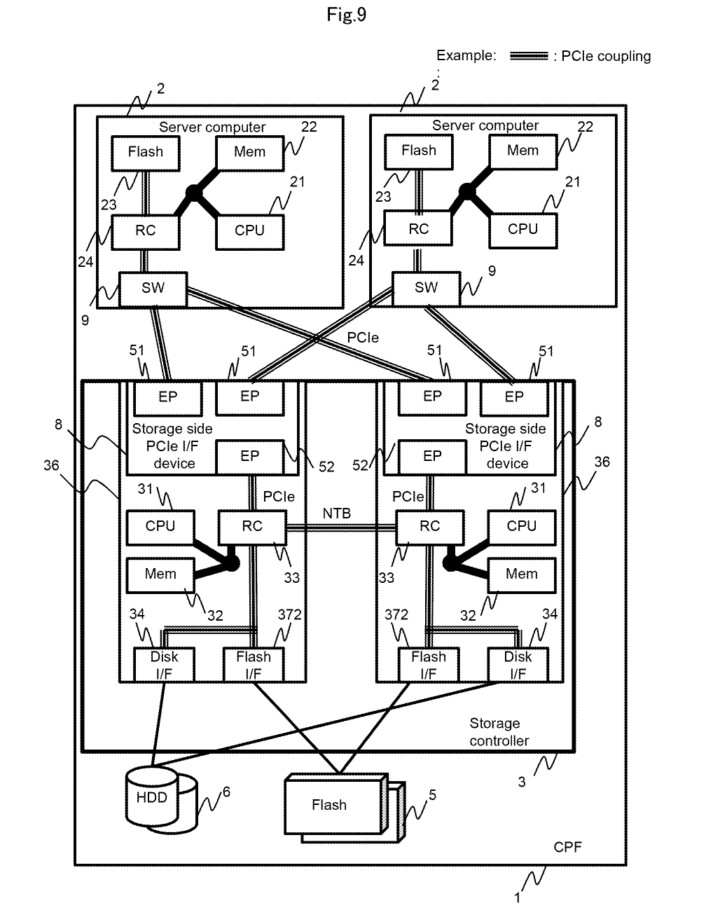

The substances of the PCIe I/F 262 and the PCIe I/F 362 are, for example, a server side PCIe I/F device 4 depicted in FIG. 4 and a storage side PCIe I/F device 8 depicted in FIG. 9.

<<CPF Under NVMe Control+SCSI Control>>

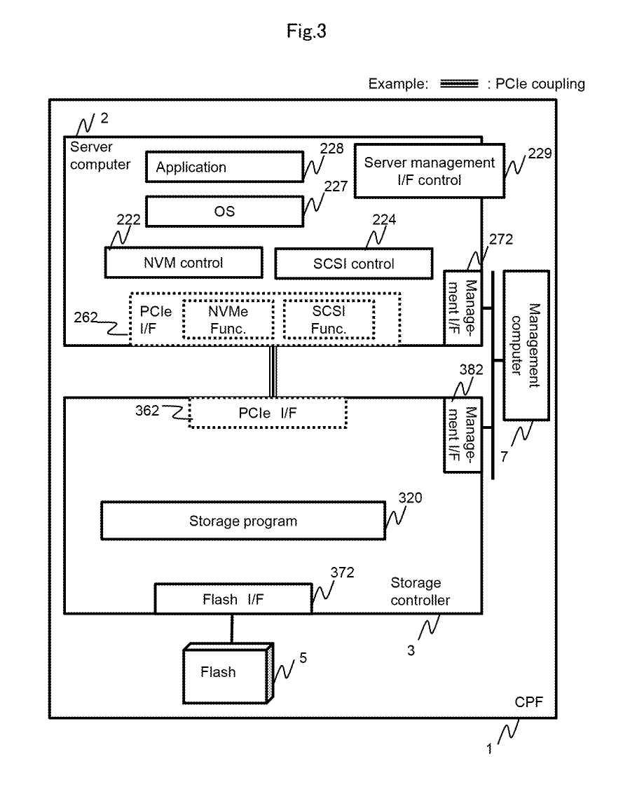

FIG. 3 is other diagram depicting a physical configuration and a logical configuration of the CPF.

A difference from FIG. 2 is that both NVMe and SCSI are used for I/O requests from the server computer 2 to the storage controller 3.

A SCSI control program 224 issues a SCSI request for a LUN provided by the storage controller 3 to a SCSI function (SCSI Func. in the figures) of the PCIe I/F 262 in accordance with a request from other program. The SCSI control program 224 is, for example, a SCSI device driver. The SCSI control program 224 may be a part of other program stored in the server computer 2 or a program different from the other program stored in the server computer 2. For example, a device driver in the OS 227 may issue SCSI requests.

To accept both an NVMe command and a SCSI request, the PCIe I/F 262 needs to have two functions, an NVMe function (NVMe Func. in the figures) and a SCSI function. Of the two functions, the NVMe function has been described in the description of the PCIe I/F 262 in FIG. 2. The SCSI function transmits a SCSI command to the PCIe I/F 362 in accordance with operation of the SCSI control program 224, and then receives a response to the SCSI command from the PCIe I/F 362. The SCSI function then returns the response to the SCSI control program 224. Whether or not the PCIe I/F 362 has multiple functions depends on whether the intermediate device interprets NVMe commands.

A server computer 2 being able to issue both NVMe commands and SCSI commands has at least one of the following advantages.
NVMe-incompatible programs in the server computer 2 are enabled to access the storage areas corresponding to the NVMe NSs.
NVMe-incompatible programs in the server computer 2 are enabled to access a storage area different from the storage areas corresponding to the NVMe NSs. For example, when an HDD is connected to the storage controller 3, the server computer 2 is enabled to access a storage area in the HDD based on SCSI.
At the point in time of filing of the application, NVMe I/Fs have not been standardized to be able to use the NSs as a boot device for the server computer 2. Thus, when the storage area provided by the storage controller 3 is used as a boot device for the server computer 2, the server computer 2 needs to be able to access the storage area using a SCSI request. The booting of the server computer 2 means that a BIOS (Basic Input/Output System) program for the server computer 2 needs to be implemented so as to be able to handle an EP with the boot device. The EP in this case is, for example, a SCSI HBA (Host Bus Adapter) or a PCIe I/F device (NVMe function or SCSI function). A specific method for implementing the EP is as follows:
The BIOS program acquires a device driver program for the BIOS program from a discovered EP and executes the device driver program.
The BIOS program itself includes a driver program for NVMe.

The server computers 2 are classified into the following three types:

(A) A type that issues NVMe commands but does not issue SCSI requests.

(B) A type that issues both NVMe commands and SCSI commands.

(C) A type that does not issue NVMe commands but issues SCSI commands.

Here, the CPF 1 may include one server computer 2 or a plurality of server computers 2. When the CPF 1 includes a plurality of server computers 2, the server computers 2 included in the CPF 1 may be of one of the types (A) to (C), a combination of any two of the types (A) to (C), or a combination of the three types (A) to (C).

<General Hardware Configuration of the CPF Using the Candidate (3)>

FIG. 4 is a diagram depicting the details of the CPF 1 in which the above-described NVMe interpretation section is the candidate (3). The PCIe connection between the server computer 2 and the storage controller 3 is made via a switch, but this is omitted in FIG. 4.

The server computer 2 includes a CPU 21, a main memory 22 (abbreviated as Mem in the figures and hereinafter sometimes referred to as a memory 22), an RC 24, and a server side PCIe I/F device 4. The RC 24 and the server side PCIe I/F device 4 are connected together based on PCIe. The RC 24 and the CPU 21 are connected together by a network that operates faster than a PCIe network. The memory 22 is connected by a high-speed network to the CPU 21 and the RC 24 via a memory controller not depicted in the drawings. The above-described programs executed by the server computer 2 are loaded into the memory 22 and executed by the CPU 21. The CPU 21 may be a CPU core. The RC 24 and the CPU 21 may be integrated together into one LSI package.

The server side PCIe I/F device 4 is an example of the above-described intermediate device. The server side PCIe I/F device 4 maybe arranged outside the server computer 2. The server side PCIe I/F device 4 has the following features:
The server side PCIe I/F device 4 interprets NVMe commands issued by the programs executed by the CPU 21.
The server side PCIe I/F device 4 provides an EP 41 to the RC 24.
The server side PCIe I/F device 4 provides another EP 42 to an RC 33 included in the storage controller 3. When the storage controller 3 needs to include a plurality of RCs and the server side PCIe I/F device 4 needs to communicate each of the RCs, the server side PCIe I/F device 4 provides different EPs 42 to the respective RCs. In this case of figure, the server side PCIe I/F device 4 provides two EPs 42 to the respective two RCs 33 in the storage controller 3.

To implement these features, the server side PCIe I/F device 4 may include a logic that provides a plurality of EPs 42 corresponding to the respective plurality of server computers 2, a logic that provides the EP 41, and a logic that issues a SCSI command based on an NVMe command to the storage controller 3. The EP 41 corresponds to the PCIe I/F 262 in FIG. 2, and the EP 42 corresponds to the PCIe I/F 362. Moreover, the server side PCIe I/F device 4 may include a logic that issues a SCSI request based on a SCSI request issued by the CPU 21 to the storage controller 3, as a logic corresponding to the SCSI function in FIG. 3. Each of the logics may be implemented by hardware such as a dedicated circuit or a processor that executes software.

The case where the server side PCIe I/F device 4 has both the NVMe function and the SCSI function has, for example, one or more of the following advantages compared to a case where these functions are implemented on different boards:
Costs are reduced.
A space in the server computer 2 is reduced into which a device for PCIe connection is inserted.
The number of PCIe slots used in the server computer 2 is reduced. In particular, when the above-described multiple functions are implemented in the candidate (3), the logic that allows the server side PCIe I/F device 4 to transmit a SCSI request to the storage controller 3 can be shared between the functions. This enables a reduction in the size and cost of the device.

The server computer 2 may include the local flash memory device 23 (abbreviated as Flash in the figures) as described above. The local flash memory device 23 is connected to the RC 24 based on PCIe.

For each of the types of components in the server computer 2, a plurality of components of that type may be included in the server computer 2. FIG. 4 depicts that the local flash memory device 23 and the server side PCIe I/F device 4 communicate with each other via the RC 24. However, the local flash memory device 23 and the server side PCIe I/F device 4 may communicate with each other without the RC 24 or may be unable to communicate with each other.

The storage controller 3 includes one or more (two in FIG. 4) control units 36 (abbreviated as CTL units in the figures). Each of the control units 36 includes a CPU 31, a main memory 32 (abbreviated as Mem in the figures and hereinafter referred to as a memory 32), an RC 33, and a flash I/F 372. The RC 33, the server side PCIe I/F device 4, and the flash I/F 372 are connected together based on PCIe. The RC 33 and the CPU 31 are connected together by a network that operates faster than PCIe. The main memory 32 is connected by a high-speed network to the CPU 31 and the RC 33 via a memory controller not depicted in the drawings. The programs such as the storage program 320 which are executed by the storage controller 3 as described above are loaded into the memory 32 and executed by the CPU 31. The CPU 31 may be a CPU core. The RC 33 and the CPU 31 may be integrated together into one LSI package.

Each of the control units 36 may include a disk I/F 34 for connection to the HDD 6. If the flash I/F 372 and the disk I/F 34 are of the same interface type, the two I/Fs may merge into a common I/F. The disk I/F 34 may be based on SAS, SATA, FC, or Ethernet or any other communication mechanism may be used.

FIG. 4 depicts that the flash I/F 372 (or the disk I/F 34) and the server side PCIe I/F device 4 communicate with each other via the RC 33. However, the flash I/F 372 (or the disk I/F 34) and the server side PCIe I/F device 4 may communicate with each other without the RC 33 or may be unable to communicate with each other. This also applies to the flash I/F 372 and the disk I/F 34.

For each of the types of components in the control unit 36, a plurality of components of that type may be included in the control unit 36.

The control units 36 can desirably communicate with each other. By way of example, FIG. 4 depicts that the RC 33 are connected together based on PCIe. When the RC 33 are connected together based on PCIe, an NTB (Non-transparent Bridge), which is not depicted in the drawings, is used for the connection. Any other mechanism may be used for communication between the control units 36.

<Range of a PCIe Space in the CPF Using the Candidate (3)>

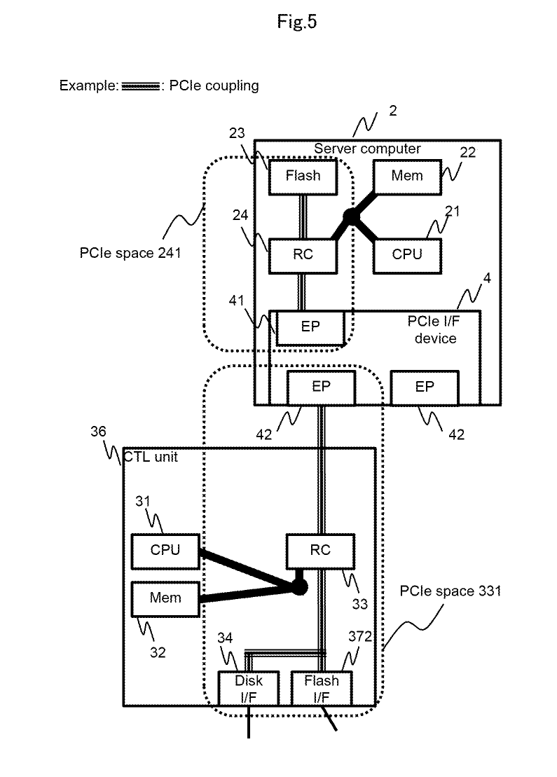

FIG. 5 is a figure that illustrates an enlarged FIG. 4 around the server side PCIe I/F device 4 and a PCIe space that is a space for PCIe address. A PCIe space 241 is a space controlled by the RC 24 in the server computer 2. A PCIe space 331 is a space controlled by the RC 33 in the storage controller 3. As noted in connection with the above-described “coexistence of a plurality of RCs” problem, the coexistence of a plurality of RCs in one PCIe space is impossible. Thus, to separate each PCIe space into parts of the PCIe space, the server side PCIe I/F device 4 can connect a PCIe link for the RC 24 and a PCIe link for the RC 33, and operates as an EP at each of the links.

The disk I/F 34 and the flash I/F 372 may be present in a PCIe space that is different from the PCIe space 331.

<Relation Between the NVMe NSs and the Storage Areas in the Storage Controller>

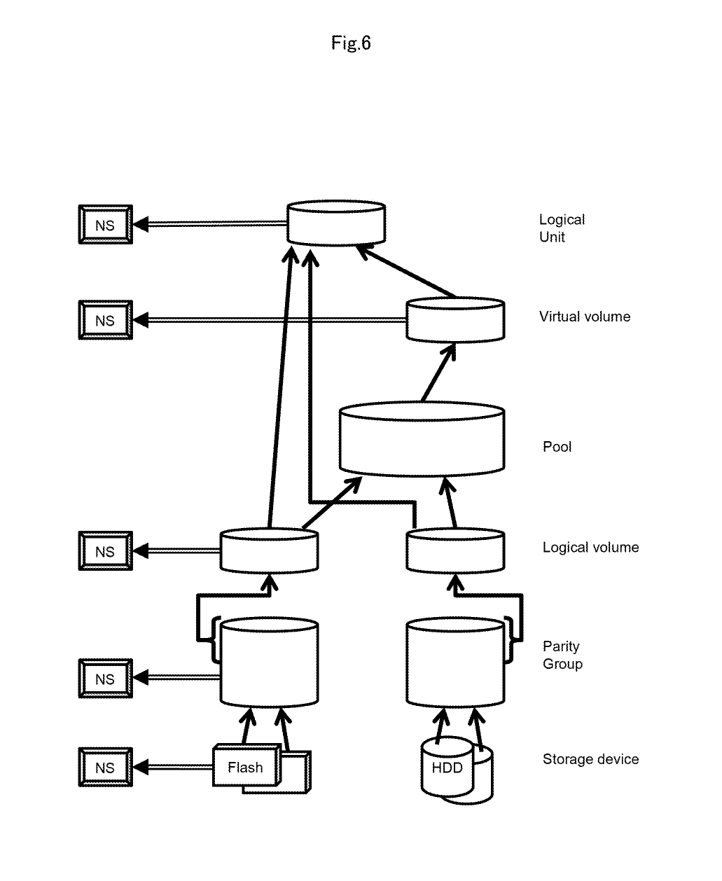

FIG. 6 is a diagram depicting the relation between the NVMe NSs and the storage areas in the storage controller 3. The storage controller 3 manages the following storage areas:
A parity group. The parity group is defined using a plurality of storage devices (the flash memory device 5 and the HDD 6). This allows high reliability, a high speed, and a large capacity to be achieved based on RAID (Redundant Arrays of Inexpensive Disks).
Logical volumes. The logical volumes are areas into which the storage area for the parity group is divided. The storage area for the parity group may have too large a capacity to directly provide in the server computer. Thus, the logical volumes are present.
A pool. The pool is a group including a storage area used for thin provisioning and tiering. In FIG. 6, logical volumes are allocated to the pool. However, the parity group or the storage device itself may be allocated directly to the pool.
Virtual volumes. The virtual volumes are virtual storage areas defined using the pool and to which thin provisioning or/and tiering are applied. A term “volumes” may hereinafter be used to indicate the logical volumes and the virtual volumes.
A logical unit (which may hereinafter be referred to as an LU). The logical unit is a storage area from the virtual volumes or the logical volumes which is allowed to be accessed by the server computer 2. A SCSI LUN (Logical Unit Number) is assigned to the logical unit.

The storage controller 3 need not provide all of the above-described types of storage areas.

The NSs may each be associated with any of these types of storage areas. However, the NSs are more preferably associated with the logical unit. This is because this association allows the storage program 320 to easily remain compatible with the storage program 320 for the SAN storage system and makes the definition of the storage areas more compatible with the definition of the storage areas in the SAN storage system. For distinction from the LUN of a logical unit associated with an NS, the LUN of a logical unit not associated with an NS may be hereinafter referred to as a SCSI LUN.

<Storage Program>

The storage program 320 executes the following processes including the above-described items (the storage program 320 need not execute all of the processes):
Receiving, interpreting, and processing a SCSI request. For example, when the SCSI request is a read request, the storage program 320 reads data from the storage device such as the flash memory device 5 or the HDD 6 and transfers the data to the server computer 2. In that regard, the main memory 32 of the storage controller 3 may be used as a cache memory. For example, when the SCSI request is a write request, the storage program 320 stores write data in the cache memory and then writes the write data to the storage device.
Executing a RAID process on the parity group.
Defining the storage areas provided by the storage controller 3. The results of the definition are stored in the main memory 32 of the storage controller 3 as storage area definition information so as to be referenced during the above-described request process.
Executing processes for enterprise functions such as thin provisioning.

<Request Conversion Process in the Candidate (3)>

As described above, for the candidate (3), the server side PCIe I/F device 4 generates a SCSI command based on an NVMe command received from the server computer 2 and transmits the SCSI command to the storage controller 3.

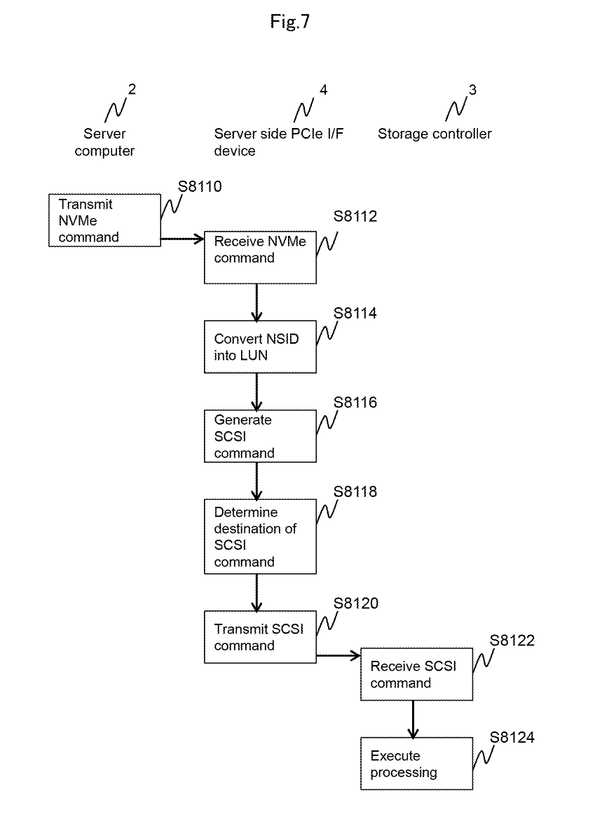

FIG. 7 is a flowchart depicting an NVMe command process executed between the server computer 2, the server side PCIe I/F device 4 and the control unit 36 and associated with an NVMe command. The process described below is applied to a case where the NVMe command is a read command and/or a write command but may be applied to any other NVMe command.

A process procedure is as described below. The following steps assume that the storage controller 3 includes a plurality of control units 36 each including a plurality of CPUs 31 and that the logical unit is associated with the NS:

(S8110) The server computer 2 transmits the NVMe command as a result of the above-described processing executed by the program. The NVMe command contains an NSID to allow a target NS to be specified. The NVMe command also contains the range of access within the NSID and the range of memory for the server computer 2.

(S8112) The server side PCIe I/F device 4 receives the NVMe command.

(S8114) The server side PCIe I/F device 4 interprets the received NVMe command to convert the NSID contained in the command into a corresponding LUN.

(S8116) The server side PCIe I/F device 4 generates a SCSI command containing the resultant LUN.

(S8118) The server side PCIe I/F device 4 determines the control unit 36 and the CPU 31 corresponding to destinations to which the generated SCSI command is to be transmitted.

(S8120) The server side PCIe I/F device 4 transmits the generated SCSI command to the determined destinations.

(S8122 and S8124) The CPU 31 of the destined control unit 36 receives and processes the SCSI command.

The transmission and reception of the NVMe command in S8110 and S8112 correspond to the following process:

(A) A program in execution in the server computer 2 records the NVMe command in an I/O queue prepared in the memory 22 of the server computer 2,

(B) The program in execution in the server computer 2 increments a tail pointer of an I/O queue in an NVMe register space at the EP 41 of the server side PCIe I/F device 4, and

(C) The server side PCIe I/F device 4 detects the increment in the head pointer of the I/O queue to fetch the NVMe command from the I/O queue in the memory 22 of the server computer 2.

In (C), a plurality of NVMe commands may be fetched. In this case, the server side PCIe I/F device 4 executes steps succeeding S8114 on each of the NVMe commands. For the order of execution, S8114 to S8124 may be serially repeatedly or parallelly executed on the NVMe commands.

Although not depicted in the drawings, when the NVMe command is determined to be a write command as a result of the processing in S8124, the server side PCIe I/F device 4 transfers write data stored in the memory 22 of the server computer 2 to the memory 32 of the storage controller 3. When the NVMe command is a read command, the server side PCIe I/F device 4 transfers read data stored in the memory 32 of the storage controller 3 to the memory 22 of the server computer 2.

Furthermore, the conversion of the NSID into the LUN in S8114 may include one of or a combination of the following operations:
The server side PCIe I/F device 4 converts the NSID into the LUN using a predetermined conversion formula (which may include a bit-wise operation). The server side PCIe I/F device 4 may also convert the LUN into the NSID using a reverse conversion formula paired with the predetermined conversion formula. A simple example of the predetermined conversion formula is NSID=LUN.
The server side PCIe I/F device 4 stores a conversion table, that allows the server side PCIe I/F device 4 to obtain the LUN from the NSID, in the memory of the server side PCIe I/F device 4, and references the conversion table during the conversion.

As described with reference to FIG. 3, the server side PCIe I/F device 4 may receive the SCSI command issued by the server computer 2 in S8112. In this case, the subsequent steps S8114 and S8116 are omitted, and for handling the SCSI command, the server side PCIe I/F device 4 determines whether the received command is an NVMe command or a SCSI command.

A method for determining the destinations in S8118 may be based on the following criteria but other criteria may be used:
Whether or not there is a failure to the control unit 36 or the CPU 31. For example, the server side PCIe I/F device 4 stores the statuses of the control units 36 resulting from the transmission and performs transmission to the control unit 36 with no fault based on the stored statuses.
The load on the control unit 36 or the CPU 31. In implementation, (A) the storage controller 3 or the management computer 7 acquires the loads on the control units 36 or the CPUs 31 and determines the control unit 36 and the CPU 31 corresponding to destinations to which a SCSI command resulting from a request destined for each NS is to be transmitted, and transmits the destinations to the server side PCIe I/F device 4, and (B) upon receiving the determination results, the server side PCIe I/F device 4 transmits the SCSI command based on the determination results.

<<Transmission of an FCP Command Containing a SCSI Command>>

The server side PCIe I/F device 4 may perform generation of an FCP (Fibre Channel Protocol) command including a SCSI command in addition to the generation of the SCSI command in S8116 and then transmit the FCP command in S8118. This has the following advantages:
The storage program 320 can perform control (access control, priority control, or the like), using a WWN (World Wide Name) or a communication identifier on the SAN such as a port ID generated from the WWN or an IP address.
Compatibility with the SAN storage subsystem can be maintained. This is advantageous both in terms of the storage program and in terms of operations.
The integrated management subsystem can acquire the connection between the server computer 2 and the storage controller 3.

When the FCP command is transmitted, the server side PCIe I/F device 4 has the following:
A virtual server port corresponding to the EP 41 (and to which a virtual WWN is assigned).
A virtual server port corresponding to the EP 42 (and to which a virtual WWN is assigned). The virtual storage port is recognized and treated like a normal SAN port by the storage program 320.

The management subsystem can specify which of the volumes is used as an NVMe NS by defining the logical unit for the virtual storage port. A process flow for the management subsystem is as follows:

(S01) The management subsystem receives a logical unit definition request specifying the storage port and the volume.

(S02) If the specified storage port is not a virtual storage port, the management subsystem transmits, to the storage controller 3, an instruction to define a logical unit corresponding to the specified volume for the storage port specified as is the case with the SAN storage subsystem.

(S03) If the specified storage port is a virtual storage port, the management subsystem transmits, to the storage controller 3, an instruction to define a logical unit corresponding to the specified volume for the specified virtual storage port.

Upon receiving the instruction in S03, the storage controller 3 executes the following processing:

(S03-1) The storage controller 3 selects the server side PCIe I/F device 4 corresponding to the specified virtual storage port.

(S03-2) The storage controller 3 defines a logical unit corresponding to the specified volume (that is, assigns an LUN to the specified volume).

(S03-3) The storage controller 3 reports the assigned LUN to the selected server side PCIe I/F device 4. The server side PCIe I/F device 4 configures the reported LUN to serve as an NS by assigning an NSID to the LUN. In this assignment process, the server side PCIe I/F device 4 generates an NSID, and if the conversion information between the NSID and the LUN is used, generates and records the information.

The process flow for the management subsystem has been described. Thus, the administrator can specify to which of the server computers 2 a volume is provided as NVMe, by specifying a virtual storage port. The specification can be achieved because each of the server side PCIe I/F devices 4 has a virtual storage port and is not shared by a plurality of server computers 2. Furthermore, when the storage controller 3 has a performance monitoring function of the logical unit, one server computer 2 is identified which imposes a load on the logical unit. As a result, the server computer 2 that imposes a load can be quickly identified. When a plurality of server computers 2 accesses a certain volume serving as a shared NS, the above-described logical unit definition is performed on each of the virtual storage ports of the server computers 2 that share the volume.

The above description is specifically intended for the FCP. However, if the description is intended for PDUs (Protocol Data Units) of iSCSIs (Internet Small Computer System Interfaces) or Ethernet frames instead of the FCP, the WWN in the above description may be replaced with an IP address or a MAC (Media Access Control) address. For generalization, the WWN in the above description may be replaced with the communication identifier (which means to include a WWN, an IP address, and a MAC address).

The management subsystem may provide a configuration mode that guards the logical unit definition for a SAN port against volumes serving as NVMe NSs. This is because, in an operation form where only temporary data are stored in the NSs, the logical unit for the SAN port may cause an unintended data update. Or, when the OS recognizes a volume both through a NS path and through a LUN path of SAN, the OS recognizes the volume as different storage areas and may thus execute an update process that leads to a data mismatch. The present guard mode can avoid such a data mismatch.

<Method for Booting the CPF>

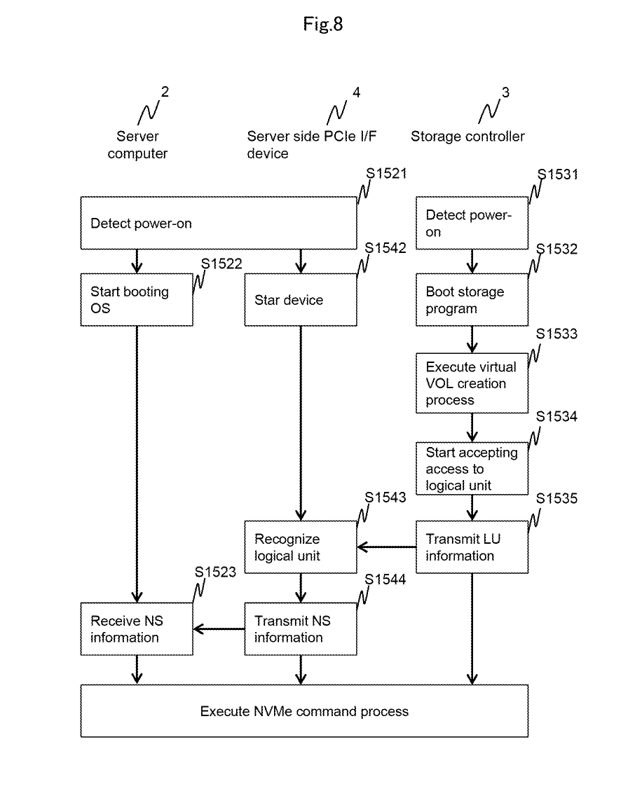

FIG. 8 is a flowchart depicting a method for booting the CPF 1.

(S1531, S1532, and S1533) Upon detecting power-on, the storage controller 3 boots the storage program 320 to start accepting accesses to the logical unit.

(S1534) The storage controller 3 transmits logical unit information (an LUN and the like) to the server side PCIe I/F device 4. The storage controller 3 may perform the transmission in accordance with a request from the server side PCIe I/F device 4 or voluntarily.

(S1521) The server computer 2 and the server side PCIe I/F device 4 detect power-on.

(S1542 and S1543) The server side PCIe I/F device 4 is started to receive the logical unit information received from the storage controller 3, thus recognizing the logical unit.

(S1544) The server side PCIe I/F device 4 generates NS information (an NSID and the like) corresponding to the recognized logical unit and transmits the NS information to the programs executed by the server computer 2. In this case, the server side PCIe I/F device 4 is expected to perform the transmission in accordance with a request from the programs in the server computer 2 but may perform the transmission voluntarily. The present step may be executed as a part of the starting of the device 4 or after the starting.

(S1522) The server computer 2 boots the programs such as the OS 227 and the application 228. Programs that need to recognize the NSs wait to receive the NS information (NSIDs and the like).

(S1523) In the server computer 2, the programs that need to recognize the NSs receive the NS information from the server side PCIe I/F device 4. As depicted in FIG. 8, when the reception in S1523 is performed, the starting of the storage controller 3 and the server side PCIe I/F device 4 has been completed. The present step may be executed as a part of the booting in S1522 or after the booting.

After the above-described process, the processing of the NVMe command described with reference to FIG. 7 is executed. As depicted in FIG. 8, power-on of the storage controller 3 is independent of power-on of the server computer 2 (and the server side PCIe I/F device 4). However, as a part of steps S1531 to S1533, the storage controller 3 may give an instruction to power the server computer 2 (and the server side PCIe I/F device 4) on.

<Case where the NVMe Interpretation Section is the Candidate (2)>

FIG. 9 is a diagram depicting the details of the CPF 1 in which the above-described NVMe interpretation section is the candidate (2). Differences from FIG. 4 are as follows:
The server side PCIe I/F device 4 is replaced with a PCIe switch (SW) 9.
A storage side PCIe I/F device 8 is newly installed in the storage controller 3. The device 8 is similar to the server side PCIe I/F device 4. However, in the device 8, the number of EPs 51 connected to the server computers 2 is set to be at least the number of the server computers 2 in order to solve the above-described “coexistence of a plurality of RCs” problem by providing the EPs 51 to each of the server computers 2. Moreover, the device 8 provides EPs 52 to RCs 33 in the storage controller 3.

The storage side PCIe I/F device 8 may execute an NVMe command process in accordance with the flow described with reference to FIG. 7. However, the device 8 may perform an efficient NVMe queue control considering with the internal status of the storage controller 3, by cooperating with the storage program 320, as described with reference to FIG. 1. For example, the NVMe command process lowers the priority of fetch from an NVMe queue related to an NS allocated to an HDD with load concentration or a fault. Furthermore, the storage side PCIe I/F device 8 may convert the NVMe command into a command format other than a SCSI format or transmit the NVMe command to the storage program 320 without any change.

<Application of the CPF 1>

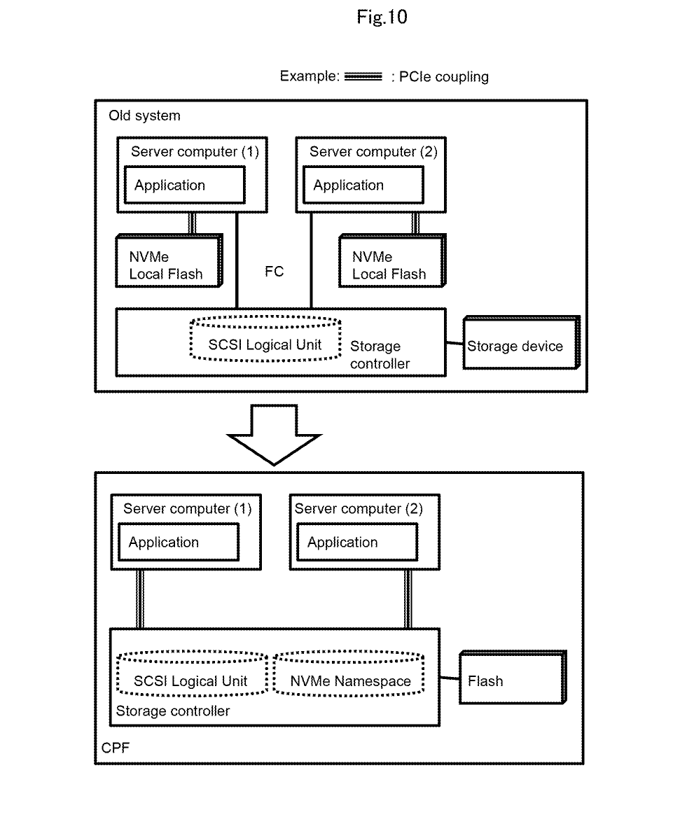

FIG. 10 depicts an example of application of the above-described CPF.

A case will be described when an application executed by an old system is shifted to the CPF. The old system includes a server computer (1), a server computer (2), two local flash memory devices (abbreviated as NVMe Local Flash in FIG. 10), a storage controller, and a storage device. The two local flash memory devices are connected to the server computers (1) and (2), respectively, based on PCIe. The storage controller is connected to the server computers (1) and (2) based on FC. The server computer (1) executes the application. The storage controller uses the storage device to provide a logical unit that supports SCSI (represented as SCSI Logical Unit in FIG. 10).

It is assumed that, in the old system, the application is utilized in accordance with the following configuration:
For the application, temporarily generated data are stored in the NSs in the local flash memory device supporting NVMe, and non-temporary data are stored in the logical unit provided by the storage controller. Thus, the application achieves high-speed processing.
If the server computer (1) is stopped, the server computer (2) resumes a process executed by the application. However, the server computer (2) fails to take over the data stored in the local flash memory device by the server computer (1), and thus read the data from the logical unit via FC to resume the processing.

Such an application can be shifted from the old system to the CPF. The CPF includes a server computer (1), a server computer (2), a storage controller, and a flash memory device (abbreviated as Flash in FIG. 10). The CPF uses the flash memory device connected to the storage controller instead of the local flash memory device connected to each of the server computers. The storage controller provides a logical unit that supports SCSI and a namespace that supports NVMe (represented as NVMe Namespace in FIG. 10), by using the flash memory device. The application in the server computer (1) executes a process by writing temporary data to the NS, which is a shared data area, and reading the temporary data from the NS. Upon determining to take over the process executed by the application in the server computer (1) to the server computer (2) as a result of a fault in the server computer (1) or the like, the server computer (2) reads the temporary data from the NS and takes over and executes the process.

Such a configuration has the following advantages:
Maintenance of the flash memory device can be consolidated.
Using the enterprise functions of the storage controller for the flash memory device allows enhancement of reliability, redundancy, functionality, maintainability, and manageability.

Moreover, if the configuration of the application is changed such that the temporary data stored in the NS are taken over from one of the server computers to the other, the amount of time can be reduced which is needed to switch from the server computer (1) to the server computer (2), as a result of a fault or the like. Thus, the MTBF (Mean Time Between Failure) of the application is improved, and the switching between the server computers is facilitated, So that the maintainability and the manageability are improved. Furthermore, the non-temporary data conventionally stored in the logical units of the SCSI be stored in the NVMe NS, thus further enhancing the application processing performance.

<Case where Thin Provisioning and Tiering are Applied to an LU>

A case will be described where the storage controller 3 provides an LU to which thin provisioning and tiering are applied, and the server side PCIe I/F device 4 associates the LU with an NS. In the thin provisioning, a virtual volume is provided to the server computer 2, and based on an access from the server computer 2 to the virtual volume, a storage area in the pool is allocated to the virtual volume. The thin provisioning is also referred to as capacity virtualization. In the tiering, data written via the server computer 2 is placed in one of a plurality of types of storage media. The tiering is also referred to as tier control virtualization or automatic tiering.

<<Configuration of Data in the Storage Controller 3>>

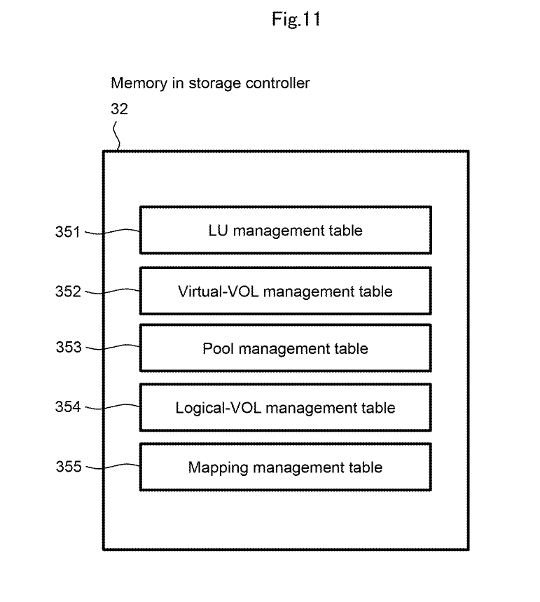

FIG. 11 depicts a configuration of data in the storage controller 3.

The storage controller 3 stores, in the memory 32, an LU management table 351, a virtual-volume management table 352, a pool management table 353, a logical-volume management table 354, and a mapping management table 355.

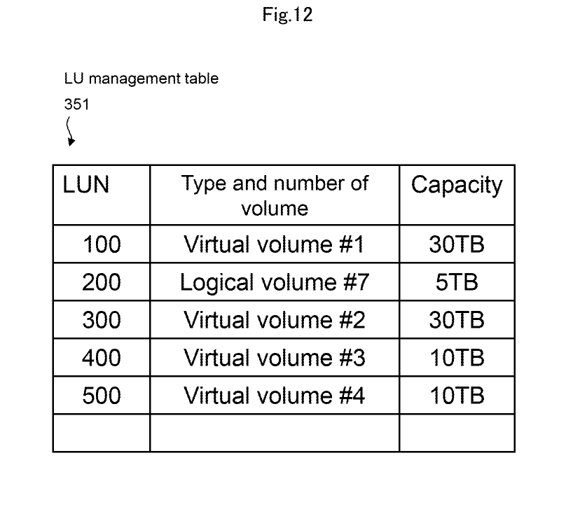

FIG. 12 depicts the LU management table 351.

The LU management table 351 includes entries for respective LUs. The entry corresponding to one LU includes an LUN, a volume type and a volume number, and an LU capacity. The LUN is an identifier indicative of the LU. The volume type is the type of a volume allocated to the LU and indicates whether the volume is a virtual volume or a logical volume. The volume number is a virtual volume number or a logical volume number indicative of the volume depending on the volume type. The LU capacity is the capacity of the volume. When the LU is accessed by the server computer 2 in accordance with the NVMe, the capacity of the NS is the LU capacity. For LUs using the thin provisioning, the volume type is indicative of the virtual volume, and the volume number is indicative of a virtual volume number. For LUs not using the thin provisioning, the volume type is indicative of the logical volume, and the volume number is indicative of a logical volume number. The LUN has an independent number space at least for each storage port (including virtual storage ports). Thus, a plurality of the present table may be present, and more specifically, the present table may be present for each storage port.

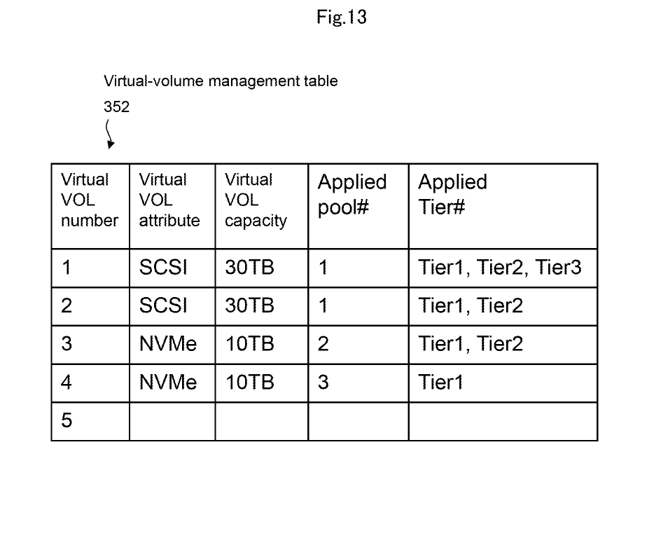

FIG. 13 depicts the virtual-volume management table 352.

The virtual-volume management table 352 includes entries for respective virtual volumes. The entry corresponding to one virtual volume includes a virtual volume number, a virtual volume attribute, a virtual volume capacity, an applied pool number (#), and an applied tier number (#). The virtual volume number is the volume number of the virtual volume. The virtual volume attribute is a protocol for the server computer 2 that accesses the virtual volume and indicates whether the protocol is the NVMe or SCSI. The virtual volume capacity is the volume capacity of the virtual volume and is configured by the administrator of the storage controller 3 during creation of the virtual volume. The applied pool number is a pool number indicative of a pool associated with the virtual volume. The applied tier number is a tier number indicative of a tier associated with the virtual volume. A smaller tier number is indicative of higher storage device performance. For example, an SSD is allocated as a storage device for a tier 1, an SAS HDD having lower access performance and lower costs than the SSD is allocated as a storage device for a tier 2, and a SCSI HDD having lower access performance and lower costs than the SAS HDD is allocated as a storage device for a tier 3. In this example, data written in accordance with a SCSI command specifying a virtual volume #1 is stored on one of the tiers 1 to 3. Data written in accordance with an NVMe command specifying a virtual volume #2 is stored on one of the tiers 1 and 2. Data written in accordance with a SCSI command specifying a virtual volume #3 is stored on one of the tiers 1 and 2. The costs of the storage device can be reduced by placing infrequently accessed data on the tier 2 using the virtual volume #3. Data written in accordance with an NVMe command specifying a virtual volume #4 is inevitably stored on the tier 1. The use of the virtual volume #4 allows provision of high-performance shared data areas. Two virtual volumes #1 and #2 accessed via the SCSI share one pool #1. Two virtual volumes #3 and #4 accessed in accordance with the NVMe are associated with two pools #2 and #3, respectively.

As described above, when the protocol used by the server computer 2 is associated with the configuration of the tiers, the server computer 2 can appropriately use access performance and the costs of storage media according to the protocol used for access. Furthermore, when a volume accessed via the NVMe command is fixed to the highest tier in a flash memory or the like, management can be facilitated by introducing pools and tiers, while high-speed accesses using the flash memory is maintained.

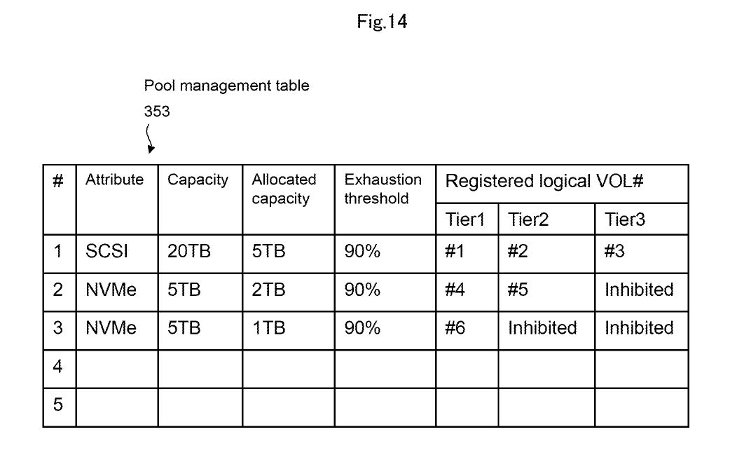

FIG. 14 depicts the pool management table 353.

The pool management table 353 includes entries for respective pools. The entry for one pool includes a pool number (#), a pool attribute, a pool capacity, an allocated capacity, an exhaustion threshold, and a registered logical volume number (#). The pool number is an identifier indicative of the pool. The pool attribute is a protocol associated with the pool and indicates whether the server computer 2 uses NVMe or the SCSI for access. The pool attribute is configured by the administrator when the pool is created. The pool capacity is the capacity of the pool and is the total of the capacities of logical volumes registered in the pool. The allocated capacity is indicative of the total of the capacities of pages allocated to the virtual volume. The exhaustion threshold is a threshold for the ratio of an allocated capacity to the pool capacity. When the ratio of the allocated capacity to the pool capacity of the pool exceeds the exhaustion threshold, the storage controller 3 gives the management computer 7 an alert requesting addition of a logical volume to the pool. The registered logical volume number is a logical volume number indicative of the logical volume registered in the pool and is configured for each tier. A logical volume number preset to “inhibited” indicates that addition of a logical volume to the corresponding tier is inhibited.

The pool management table 353 allows the storage controller 3 to allocate the logical volume to each tier in the pool. Furthermore, the storage controller 3 manages the pool capacity and the allocated capacity to allow insufficiency of the pool capacity to be detected and communicated to the administrator.

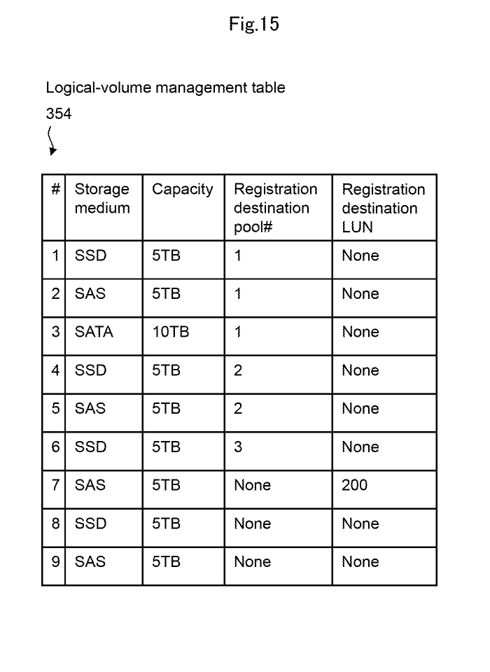

FIG. 15 depicts the logical-volume management table 354.

The logical-volume management table 354 includes entries for respective logical volumes. The entry corresponding to one logical volume includes a logical volume number (#), a storage medium, a logical volume capacity, a registration destination pool number (#), and a registration destination LUN. The logical volume is an identifier for the logical volume. The storage medium is an identifier indicative of the type of a storage medium forming the logical volume, and indicates, for example, one of SSD, SAS (HDD), and SATA (HDD). The logical volume capacity is the capacity of the logical volume. The registration destination pool number is the pool number of a pool in which the logical volume is registered. The registration destination LUN is the LUN of an LU in which the logical volume is registered. When the thin provisioning is used, logical volumes are associated with pools. When the thin provisioning is not used, logical volumes are associated with LUs. Logical volumes not associated with any pools or LUs are reserved logical volumes. The storage controller 3 registers the logical volume added by the administrator in the logical-volume management table 354 as a reserved logical volume. For example, when the pool capacity is exhausted, reserved logical volumes are added to the pool. To a pool with a plurality of tiers, a plurality of different storage media is allocated.

The SSD may have an interface such as PCIe or SAS. When a plurality of types of SSDs with different interfaces is connected to the storage controller 3, the plurality of types may be allocated to the respective plurality of tiers.

The logical-volume management table 354 allows the storage controller 3 to manage the type of a storage medium allocated to the logical volume. Consequently, the storage controller 3 can allocate a storage medium suitable for the tier to the logical volume.

The mapping management table 355 includes a first relation between virtual pages in the virtual volume and logical pages in the logical volume allocated to the pool and a second relation between the address of the logical volume (hereinafter referred to as the logical volume logical address) and the address of the storage device (storage device logical address). The virtual pages refer to individual spaces each with a predetermined length into which the address space in the virtual volume is divided. The logical pages refer to individual spaces each with a predetermined length (that is typically the same as the length for the virtual pages) into which the address space in the virtual volume is divided.

In each entry indicative of the first relation, a set of pieces of information is registered which includes a piece of information indicative of a virtual page (for example, a set of the virtual volume # and the virtual volume logical address) and a piece of information indicative of a logical page allocated to the virtual page (for example, the logical volume # and the logical volume logical address). Consequently, an access specifying the address of the virtual volume can be converted into the address of the logical volume allocated to the pool. For the thin provisioning, the logical page may have not been allocated to a virtual page. In such a case, a value indicating that the logical page has “not been allocated” is set in the above-described information representing the logical page. The content representing the first relation may be in any other form so long as the content allows the thin provisioning to be achieved, and inclusion of any other information is not excluded. For example, a page number may be assigned to each of the virtual and logical pages so that allocation relations can be represented using the page numbers.

A method for representing the second relation depends on the relation between the logical volume and the parity group and the storage device depicted in FIG. 6. However, any method may be used so long as the method allows a logical volume logical address to be converted into a storage device logical address. If one logical volume corresponds only to one parity group, the entry for the second relation is an address space in a parity group that is associated with the identifier for a parity group to which the logical volume corresponds. If allocation of one storage device to a plurality of parity groups is prevented, an identifier list for the storage devices included in the parity groups is a part of the entry. The second relation may be expressed in any other form.

The mapping management table 355 allows the storage controller 3 to acquire an address in the logical volume that corresponds to an address in the virtual volume. Furthermore, the storage controller 3 can acquire an address in the storage device that corresponds to an address in the logical volume.

<<Virtual-Volume Creation Process>>

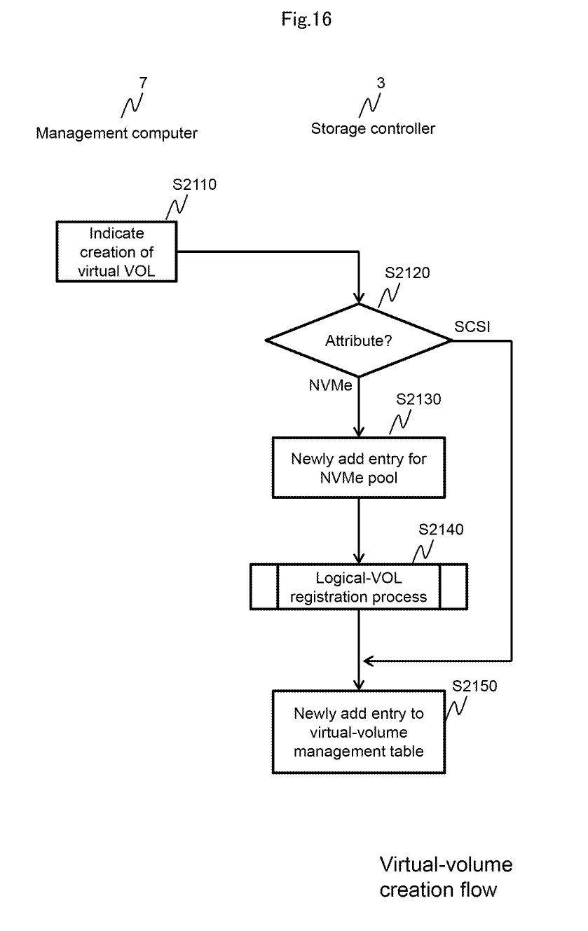

FIG. 16 depicts a virtual volume creation process.

The virtual-volume creation process includes the following processing: (S2110) The administrator allows the management computer 7 to display a virtual-volume creation screen, and on the screen, inputs an indication to create a virtual volume. Then, the management computer 7 issues the indication to the storage controller 3.

(S2120) Subsequently, the storage controller 3 determines whether or not the virtual volume attribute of the virtual volume is the NVMe, based on the indication. Upon determining the virtual volume attribute not to be the NVMe, that is, the virtual volume attribute to be the SCSI (SCSI), the storage controller 3 shifts the processing to S2150. On the other hand, upon determining the virtual volume attribute to be the NVMe (NVMe), the storage controller 3 shifts the processing to S2130.

(S2130) The storage controller 3 adds an entry for an NMe pool to the pool management table 353 and configures permission or inhibition of registration of the logical volume for each tier based on the indication.

(S2140) Subsequently, the storage controller 3 executes a logical volume registration process in which the pool is specified to allow the logical volume to be registered in the pool.

(S2150) Subsequently, the storage controller 3 adds an entry for the virtual volume associated with the pool to the virtual-volume management table 352, and ends the flow.

The virtual-volume creation process allows the storage controller 3 to create a virtual volume that is accessed by the server computer 2 using the NVMe command and to create a pool that is allocated to the virtual volume. Consequently, by allocating the created pool only to one virtual volume, the storage controller 3 can manage the capacity of the virtual volume and manage the capacity of the pool corresponding to the virtual volume. When a plurality of virtual volumes for the NVMe shares the pool, the storage controller 3 may select a suitable pool in S2130 and S2140 as is the case with the SCSI (the selection may be performed using a method of receiving the identifier for the pool from the administrator or a method in which the management computer makes selection in accordance with a predetermined criterion), and then proceed to S2150.

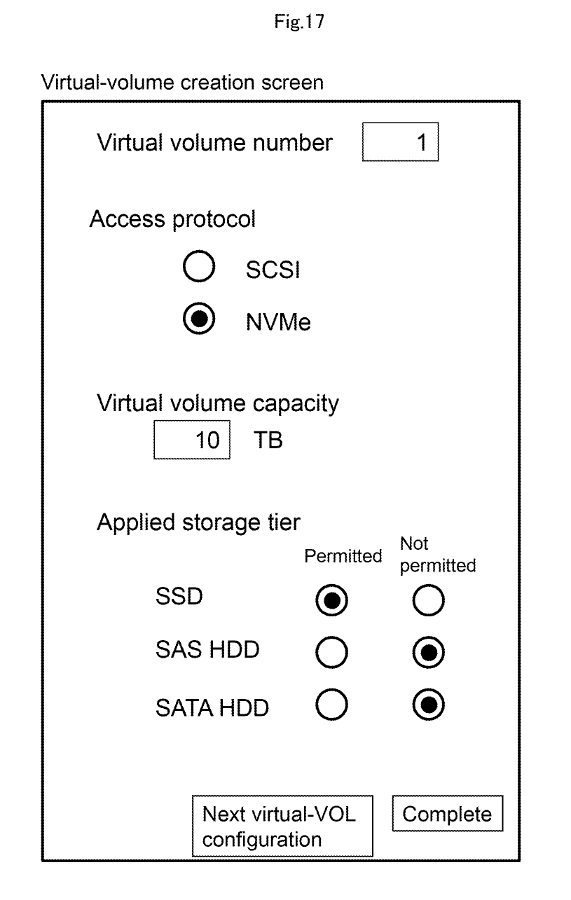

FIG. 17 depicts the virtual-volume creation screen.

The virtual-volume creation screen includes a virtual volume number, an access protocol, a virtual volume capacity, an applied storage tier, a next volume button, and a completion button. To the virtual volume number, the virtual volume number of a virtual volume to be created is input. To the access protocol, one of the SCSI and the NVMe is input as an access protocol corresponding to the virtual volume attribute of the virtual volume. To the virtual volume capacity, the virtual volume capacity, the virtual volume capacity of the virtual volume is input. The applied storage tier includes an entry for each tier. The entry corresponding to one tier indicates a storage medium corresponding to the tier. Permission or inhibition (non-permission) of utilization of the tier is input. Depressing the next volume button allows the management computer 7 to display a virtual-volume creation screen for configuration of the next virtual volume. Depressing the completion button allows the management computer 7 to issue an indication including the values input on the virtual-volume creation screen, to the storage controller 3.

In this example, the type of the storage medium in the storage device allocated to the tier 1 is SSD. The SSD is connected to a flash I/F 372. The flash I/F 372 is PCIe, SAS, or the like. The type of the storage medium in the storage device allocated to the tier 2 is SAS HDD. The SAS HDD is connected to the disk I/F 34. The disk I/F 34 is SAS. The type of the storage medium in the storage device allocated to the tier 3 is SATA HDD. SATA HDD is connected to the disk I/F 34. The disk I/F 34 is SATA.

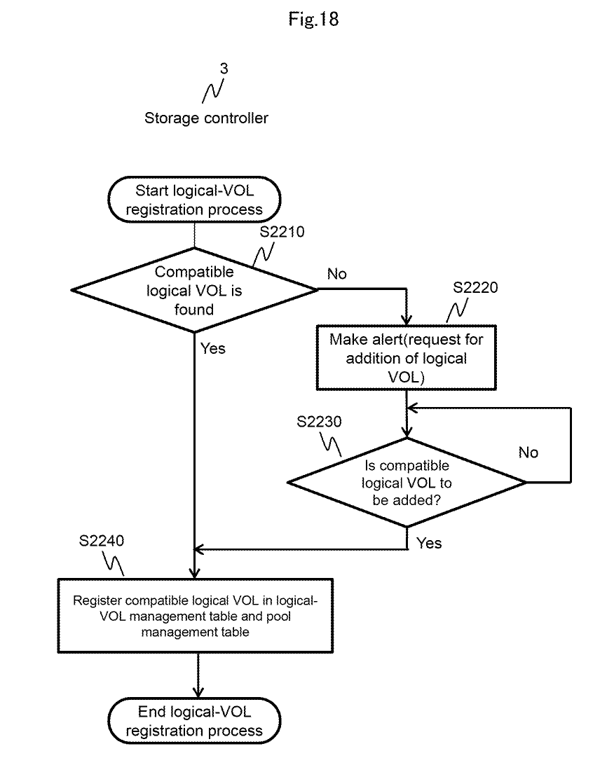

FIG. 18 depicts a logical-volume registration process.

The storage controller 3 executes the logical-volume registration process for each tier permitted to be registered in the pool, based on information on the storage tiers utilized for the specified pool. The logical-volume registration process for the specified pool and tier includes the following processing:

(S2210) The storage controller 3 searched the logical-volume management table 354 to determine whether or not any logical volume is compatible with the specified pool. In this case, the compatible logical volume is a reserved logical volume in the storage medium that corresponds to the specified tier. Upon determining that any logical volume is compatible with the pool (Yes), the storage controller 3 shifts the processing to S2240. On the other hand, upon determining that no logical volume is compatible with the pool (No), the storage controller 3 shifts the processing to S2220.

(S2220) The storage controller 3 gives an alert to the management computer 7 to urge the administrator to add a new logical volume.

(S2230) Subsequently, the storage controller 3 determines whether or not any logical volume compatible with the pool has been added. Upon determining that no logical volume compatible with the pool has been added (No), the storage controller 3 repeats S2230. On the other hand, upon determining that any logical volume compatible with the pool has been added (Yes), the storage controller 3 shifts the processing to S2240.

(S2240) The storage controller 3 adds information on the logical volume determined to be compatible with the pool, to the logical-volume management table and the pool management table, and ends the flow. In this case, if a plurality of logical volumes is determined to be compatible with the pool, the storage controller 3 may sequentially select one of the plurality of logical volumes in a preset order of number.

The logical-volume registration process allows the storage controller 3 to register the logical volume compatible with the specified pool and tier, in the pool.

<<Write Process on the Virtual Volume>>

When the server computer 2 transmits an NVMe Write command to the server side PCIe I/F device 4, the server side PCIe I/F device 4 executes the above-described NVMe command process the server side PCIe I/F device 4 executes the above-described NVMe command process to convert the NVMe Write command into a SCSI Write command, and transmits the SCSI Write command to the storage controller 3. In this case, the NVMe Write command specifies an NS. The SCSI Write command resulting from the conversion specifies an LU associated with the NS. Subsequently, the storage controller 3 executes a write process for write to the virtual volume.

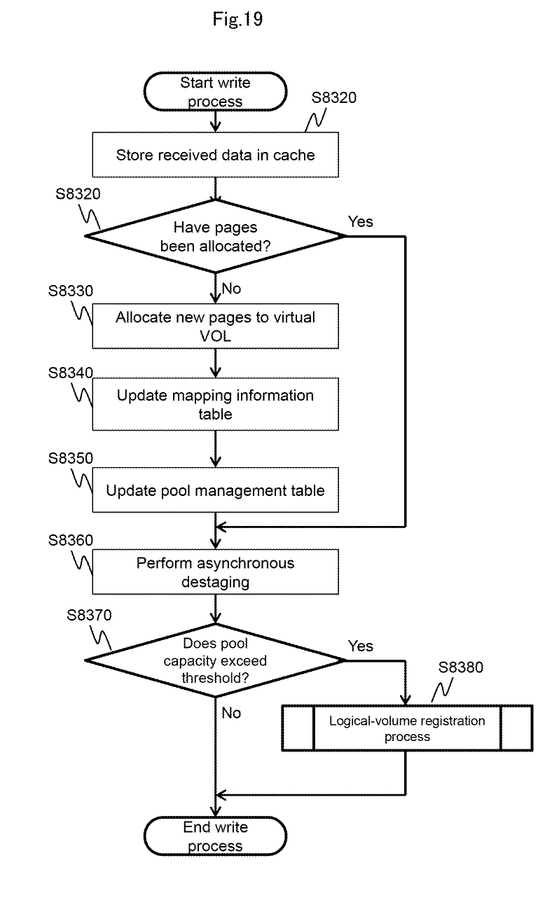

FIG. 19 depicts the write process executed on the virtual volume.

The write process includes the following processing:

(S8310) Upon receiving the SCSI Write command, the storage controller 3 transmits a request for transfer of write data to the server side PCIe I/F device 4. Subsequently, the server side PCIe I/F device 4 transfers write data stored in the memory 22 of the server computer 2 to the memory 32 (cache memory) of the storage controller 3.

(S8320) Subsequently, the storage controller 3 references the LU management table 351 to select a virtual volume corresponding to an LU specified in the Write command from the server side PCIe I/F device 4. Subsequently, the storage controller 3 references the mapping management table 355 to determine whether or not any page has been allocated to the write target virtual-volume logical address in the virtual volume specified in the Write command. Upon determining that any page has been allocated to the write target virtual-volume logical address, the storage controller 3 shifts the processing to S8360. On the other hand, upon determining that no page has been allocated to the write target virtual-volume logical address, the storage controller 3 shifts the processing to S8330.

(S8330, S8340, S8350) The storage controller 3 allocates an unused (new) page in the pool corresponding to the virtual volume, to the write target virtual-volume logical address. Subsequently, the storage controller 3 adds information on the allocated page to the mapping management table 355. Subsequently, the storage controller 3 increases the allocated capacity of the pool in the pool management table 353 by an amount equal to the size of the page.

(S8360) Subsequently, the storage controller 3 performs asynchronous destaging in which the storage controller 3 asynchronously writes write data in the memory 32 to the storage device. In this case, the storage controller 3 acquires a storage device logical address corresponding to the page corresponding to the write target based on the mapping management table 355, and writes the write data to the storage device logical address.

(S8370) Subsequently, the storage controller 3 determines, based on the pool management table 353, whether or not the ratio of the allocated capacity to the pool capacity of the pool exceeds an exhaustion threshold. Upon determining that the ratio does not exceed the exhaustion threshold, the storage controller 3 ends the flow. On the other hand, upon determining that the ratio exceeds the exhaustion threshold, the storage controller 3 shifts the processing to S8380.

(S8380) The storage controller 3 specifies the pool to execute the above-described logical-volume registration process, and ends the flow.

Similarly to the SCSI Write command, the write process allows data to be written to the virtual volume for thin provisioning even if the server computer 2 issues the NVMe Write command.

<<NVMe Command Response Process>>

In the above-described NVMe command process, when the server computer 2 transmits an NVMe command to the server side PCIe I/F device 4, the server side PCIe I/F device 4 converts the NVMe command into a SCSI command and then transmits the SCSI command to the storage controller 3. Subsequently, the storage controller 3 executes an NVMe command response process in which a response is transmitted to the server computer 2 via the server side PCIe I/F device 4.

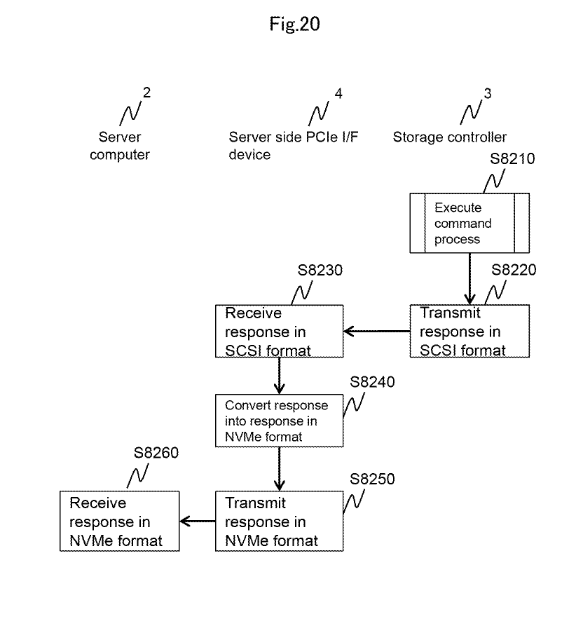

FIG. 20 depicts the NVMe command response process.

The NVMe command response process is executed by the server computer 2, the server side PCIe I/F device 4, and the storage controller 3. The NVMe command response process includes the following processing:

(S8210, S8220) The storage controller 3 executes a process in accordance with the SCSI command from the server side PCIe I/F device 4, and transmits a response in a SCSI format corresponding to the SCSI command, to the server side PCIe I/F device 4.

(S8230, S8240, S8250) Subsequently, the server side PCIe I/F device 4 receives the response in the SCSI format from the storage controller 3, converts the received response into a response in an NVMe format, and transmits the response resulting from the conversion to the server computer 2.

(S8260) Subsequently, the server computer 2 receives the response in the NVMe from the server side PCIe I/F device 4, and ends the flow.

The above-described NVMe command response process allows the storage controller 3 to transmit the response corresponding to the SCSI command to the server side PCIe I/F device 4 in accordance with a program conforming to the SCSI, while allowing the server computer 2 to process the response from the server side PCIe I/F device 4 in accordance with a program conforming to the NVMe. The NVMe command response process further allows the server computer 2 to acquire response parameters by issuing an Identify command to the server side PCIe I/F device 4.

<<Response to the Identify Command>>

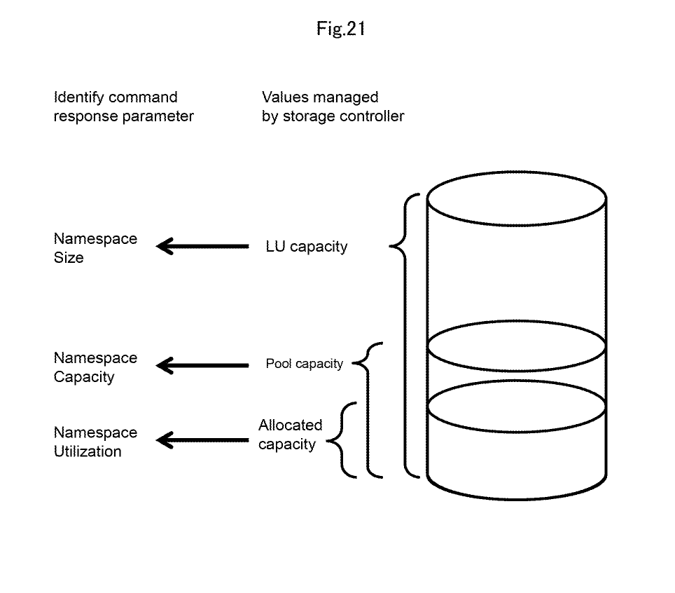

FIG. 21 depicts a relation between the response to the Identify command and storage capacities.

The Identify command, which is one of the NVMe commands, specifies an NS and acquires the status of thin provisioning for the NS. As described in NPL 1, the response to the Identify command includes a field of a plurality of parameters. The plurality of parameters includes a namespace size (hereinafter simply referred to as an NS size), a namespace capacity (hereinafter simply referred to as an NS capacity), a namespace utilization (hereinafter simply referred to as NS utilization), and namespace features (hereinafter simply referred to as NS features). For the NS size, the total size of the NS is expressed in the number of logical blocks. One logical block corresponds to one LBA. An LBA size that is the size of the logical block is, for example, 512 B. The NS size in the present embodiment corresponds to the LU capacity of an LU associated with the NS or the virtual volume capacity of a virtual volume allocated to the LU. The NS capacity expresses the pool capacity of a pool that can be allocated to the NS, in the number of logical blocks. The NS capacity in the present embodiment corresponds to the pool capacity of the pool associated with the LU. The NS utilization expresses the total size of storage areas allocated to the NS, in the number of logical blocks. The NS utilization in the present embodiment corresponds to the allocated capacity that is the total capacity of pages in the pool allocated to the virtual volume. The NS features indicate whether or not the NS supports the thin provisioning.

The storage controller 3 manages the storage areas in the pool allocated to the virtual volume, in page units. The page is, for example, 42 MB in size.

As viewed from the user of the server computer 2, a value resulting from subtraction of the NS utilization from the NS capacity corresponds to the capacity of free areas in the NS. If a plurality of NSs shares one pool, free areas in the US used by the user of the server computer 2 may be consumed by another NS used by the user of another server computer 2. Therefore, one NS desirably corresponds to one pool.

<<Inquiry Process>>

When the server computer 2 issues the Identify command specifying an NS, the above-described NVMe command process is executed to allow the server side PCIe I/F device 4 to convert the NVMe Identify command into a SCSI Inquiry command and to transmit the SCSI Inquiry command to the storage controller 3. Consequently, the NS in the Identify command is converted into an LU in the Inquiry command. Subsequently, the storage controller 3 executes an inquiry process corresponding to the Inquiry command in S8120 of the above-described NVMe command response process.

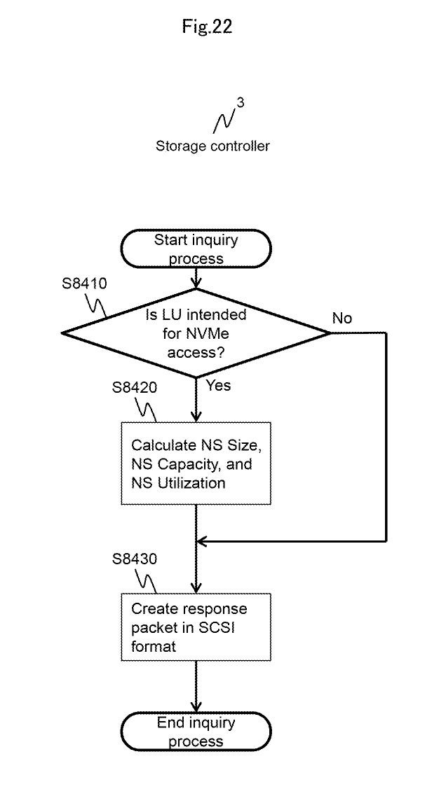

FIG. 22 depicts the inquiry process.

The inquiry process includes the following processing:

(S8410) The storage controller 3 identifies a virtual volume corresponding to the LU specified in the Inquiry command based on the LU management table 351, and determines whether or not a virtual volume attribute corresponding to the LU specified in the Inquiry command is the NVMe, based on the virtual-volume management table 352. Upon determining that the virtual volume attribute is not the NVMe but the SCSI, the storage controller 3 shifts the processing to S8430. On the other hand, upon determining that the virtual volume attribute is the NVMe, the storage controller 3 shifts the processing to S8430.

(S8420) The storage controller 3 acquires the virtual volume capacity of the virtual volume from the virtual-volume management table 352, acquires the pool capacity and the allocated capacity of the pool corresponding to the virtual volume from the pool management table 353, and based on the information acquired, calculates the following response parameters specified in the NVMe standard.

NS size=virtual volume capacity/LBA size

NS capacity=pool capacity/LBA size

NS utilization=allocated capacity/LBA size

When the allocated capacity is expressed in the number of allocated pages, the storage controller 3 calculates the allocated capacity by multiplying the number of allocated pages by a page size. Moreover, when the LU is associated with a virtual volume, that is, the thin provisioning is used for the LU, the storage controller 3 configures the NS features to 1. When the LU is associated with a logical volume, that is, the thin provisioning is not used for the LU, the storage controller 3 configures the NS features to 0. The NVMe standard specifies a relation NS size NS capacity NS utilization. When the pool capacity is larger than the virtual volume capacity, the storage controller 3 sets the NS capacity in the response parameters equal to the NS size. Consequently, the storage controller 3 calculates the response parameters in conformity with the NVMe standard.

(S8430) Subsequently, the storage controller 3 creates a response packet for the SCSI Inquiry command using the response parameters, and transmits the response packet to the server side PCIe I/F device 4 to end the flow. For example, the storage controller 3 includes the NS size, the NS capacity, the NS utilization, and the NS features in free areas in the format of the response packet for the Inquiry command. The server side PCIe I/F device 4 converts the Inquiry response packet into an Identify response packet and transmits the Identify response packet to the server computer 2. Consequently, even when the storage controller 3 does not interpret the NVMe, the server computer 2 can receive response packets conforming to the NVMe standard.

As described above, application of the thin provisioning to the LU allows a plurality of the server computers 2 to share an NS with the capacity thereof virtualized. The application also enables a reduction in design of storage capacities and in initial cost of storage devices. Moreover, application of the tiering to NUs allows a plurality of the server computer 2 to share automatically tiered NSs. Furthermore, for example, placing frequently accessed data on a high-performance tier allows access performance to be improved, and placing infrequently accessed data on a low-priced tier enables a reduction in cost for storage capacities.

<Case where the Thin Provisioning is Applied to the LU with the Tiering Not Applied to the LU>

Differences will be described which are present between the case where the thin provisioning and the tiering are applied to the LU as described above and a case where the thin provisioning is applied with the tiering not applied.

When the thin provisioning is applied with the tiering not applied, the storage controller uses a virtual-volume management table 352b instead of the virtual-volume management table 352, a pool management table 353b instead of the pool management table 353, and a logical-volume management table 354b instead of the logical-volume management table 354.

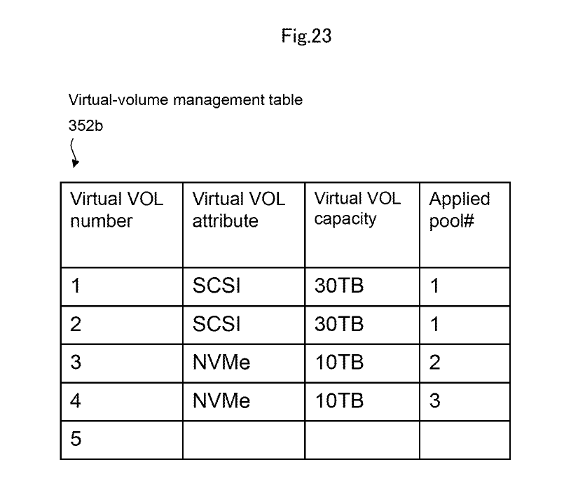

FIG. 23 is the virtual-volume management table 352b for the case where the thin provisioning is applied with the tiering not applied. Compared to the virtual-volume management table 352, the virtual-volume management table 352b includes no applied tier number.

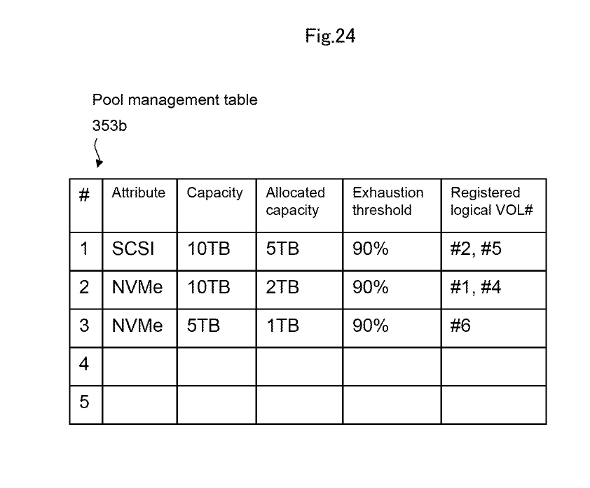

FIG. 24 depicts the pool management table 353b for the case where the thin provisioning is applied with the tiering not applied. Whereas the registered logical volume number in the pool management table 353 is indicative of a logical volume number for each tier, the registered logical volume number in the pool management table 353b is indicative of the logical volume number of a logical volume registered in the pool.

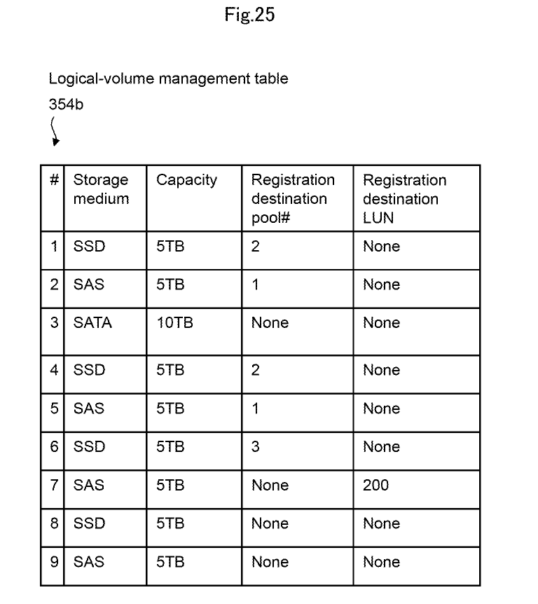

FIG. 25 depicts the logical-volume management table 354b for the case where the thin provisioning is applied with the tiering not applied. Compared to the logical-volume management table 354, the logical-volume management table 354b contains logical volumes based on the same storage medium and allocated to one pool.

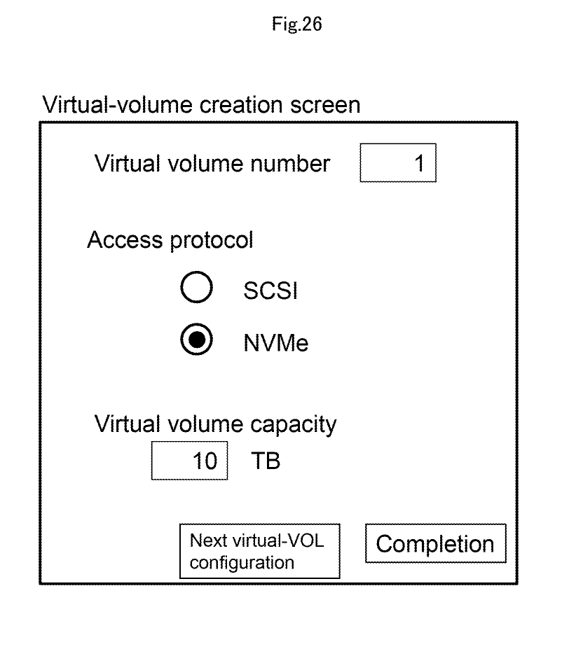

FIG. 26 depicts a virtual volume creation screen for the case where the thin provisioning is applied with the tiering not applied. Compared to the virtual-volume creation screen for the case where the tiering is applied, this virtual-volume creation screen needs no item for the applied storage tier.

Consequently, a plurality of the server computers 2 can share NSs with the capacities thereof virtualized. Furthermore, the design of storage capacities and the initial cost of storage devices can be reduced.

<Case where the Tiering is Applied to the LU with the Thin Provisioning Not Applied to the LU>

Differences will be described which are present between the case where the thin provisioning and the tiering are applied to the LU as described above and a case where the tiering is applied with the thin provisioning not applied.

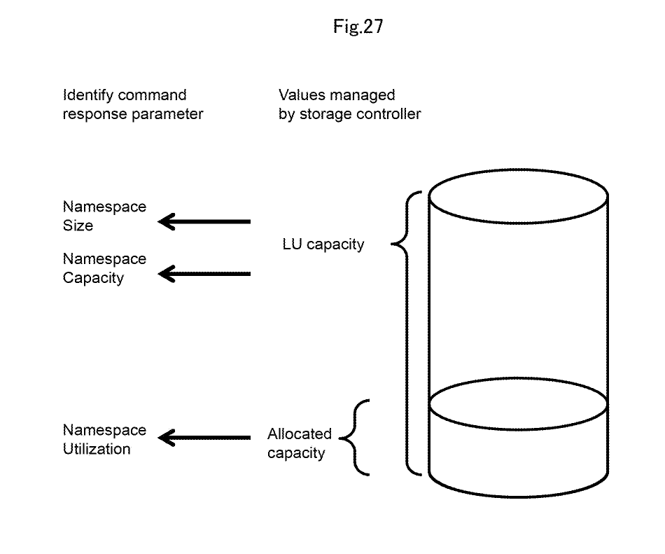

FIG. 27 depicts a relation between the response to the Identify command and storage capacities for the case where the thin provisioning is not applied.

In an inquiry process corresponding to an Identify command for an LU to which the thin provisioning is not applied, the storage controller 3 sets the NS size equal to the NS capacity.

When the thin provisioning is applied with the tiering not applied, the storage controller uses an LU management table 351c instead of the LU management table 351 and does not use the virtual-volume management table 352 or the pool management table 353.

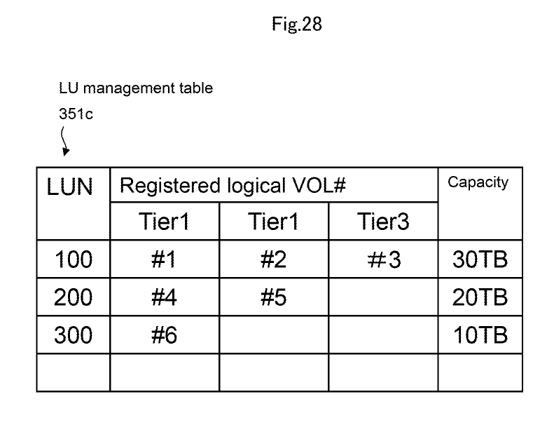

FIG. 28 depicts the LU management table 351c for the case where the tiering is applied with the thin provisioning not applied.

When the tiering is applied with the thin provisioning not applied, the storage controller 3 allocates a plurality of logical volumes corresponding to the respective plurality of tiers, to one LU, and registers the total of the capacities of the plurality of logical volumes in the LU management table 351c as an LU capacity.

Consequently, a plurality of the server computers 2 can share automatically tiered NSs. Furthermore, for example, placing frequently accessed data on a high-performance tier allows access performance to be improved, and placing infrequently accessed data on a low-priced tier enables a reduction in cost for storage capacities.

The computer system may include, as interface devices, intermediary devices such as the server side PCIe I/F device 4 and the storage side PCIe I/F device 8. The computer system may include, as a communication mechanism, a substrate such as a backplane, or as a communication mechanism, the chassis of the blade server system, the chassis of the storage controller, PCIe coupling cables, and the like. The computer system may include a plurality of server computers, a storage controller, and a chassis, a rack, or the like as an enclosure that houses a communication mechanism. The server computer may include the RC 24 as a server side RC. The server computer may include the RC 33 as a storage side RC. The interface device may provide the EP 41 or the like as a first EP and provide, as a second EP, an EP 41 or the like different from the first EP. The interface device may provide the EP 42 or the like as a third EP. The server computer may use temporary data, data needed for handover, or the like as first data and may use data unnecessary for handover or the like as second data. The computer system may include a local flash memory device as a local nonvolatile memory device. The computer system may use a virtual volume or the like as a virtual storage area. The computer system may use a logical volume or the like as a shared storage area. The computer system may use the SCSI or the like as a particular standard. The computer system may include SSD, SAS HDD, and SATA HDD as a plurality of storage devices. The server computer may use the NVM control program 222 or the like as a first program. The server computer may use the SCSI control program 224 or the like as a second program. As a first field, a field for the NS size or the like may be used. As a second field, a field for the NS capacity or the like may be used. As a third field, a field for the NS utilization or the like may be used.

In the above description, the case has been described where different pools are associated with the NS specified in the NVMe command from the server computer 2 and with the SCSI LUN specified in the SCSI request from the server computer 2. This means that the resources are separated from each other so as to prevent the SCSI LUN from being affected, for example, when a high-load access is made to the NS. However, top priority may be given to capacity utilization efficiency to associate the NS and the SCSI LUN with a common pool.

The embodiments have been described. Some of the points described above may be applied to SCSI commands other than the NVMe commands.

### REFERENCE SIGNS LIST

1 CPF

2 Sever computer

3 Storage controller

4 Server side PCIe I/F device

5 Flash memory device

6 HDD

7 Management computer

8 Storage side PCIe I/F device

9 PCIe switch

36 Control unit

1. A computer system comprising:
a first server computer;
a second server computer;
a nonvolatile memory device; and
a storage controller connected to the first server computer and the second server computer via PCI-Express, and connected to the nonvolatile memory device,
wherein the storage controller is configured to provide a virtual storage area shared by the first server computer and the second server computer,
a server computer that is each of the first server computer and the second server computer is configured to store a program that issues an NVM-Express command that is a command conforming to an NVM-Express standard,
the program is configured to allow the server computer to access the virtual storage area via the PCI-Express by issuing the NVM-Express command specifying a namespace associated with the virtual storage area, and
the storage controller is configured to allocate a storage area in the nonvolatile memory device to the virtual storage area based on the access.

2. The computer system according to claim 1, wherein the storage controller is configured to create the virtual storage area, associate a pool based on the nonvolatile memory device with the virtual storage area and allocate a part of the pool to the virtual storage area according to an increase in data written to the virtual storage area, and
when the server computer issues an Identify command specifying the namespace, the storage controller issues a response including a first field indicative of a value resulting from division of a capacity of the virtual storage area by an LBA size, a second field indicative of a value resulting from division of a capacity of the pool by the LBA size, and a third field indicative of a value resulting from division, by the LBA size, of a size of a storage area in the pool allocated to the virtual storage area.

3. The computer system according to claim 2, wherein when receiving an indication to create the virtual storage area, the storage controller creates the virtual storage area and the pool and associates the pool with the virtual storage area.

4. The computer system according to claim 2, wherein when the pool is larger in capacity than the virtual storage area, the storage controller configures a value of the first field in the second field in the response.

5. The computer system according to claim 1, further comprising an interface device interposed between the server computer and the storage controller by being connected to the server computer via the PCI-Express and connected to the storage controller via the PCI-Express,
wherein the storage controller is configured to provide the virtual storage area by interpreting a SCSI request and accessing the nonvolatile memory device based on the SCSI request, and the interface device includes:
a logic configured to provide a first endpoint (EP) to a first server side RC that is a Root Complex (RC) included in the first server computer;
a logic configured to provide a second EP to a second server side RC that is an RC included in the second server computer;
a logic configured to provide a third EP to a storage side RC that is an RC included in the storage controller;
a logic configured to interpret an NVM-Express command issued by the server computer and issue a SCSI request based on the interpreted NVM-Express command to the storage controller; and
a logic configured to interpret a SCSI response issued by the storage controller in response to the issued SCSI request and issue an NVMe response based on the SCSI response to the server computer.

6. The computer system according to claim 5, wherein the storage controller is configured to associate a virtual volume that is the virtual storage area and a virtual storage port, with a logical unit and allocate the logical unit to the namespace.

7. The computer system according to claim 5, wherein the program is configured to allow the server computer to issue the SCSI request, and
the interface device further includes a logic configured to interpret the SCSI request issued by the server computer and issue a SCSI request based on the SCSI request issued by the server computer.

8. The computer system according to claim 1, comprising a plurality of storage devices including the nonvolatile memory device and having different characteristics,
wherein the storage controller is connected to the plurality of storage devices, and is configured to place data to be written to the virtual storage area in one of the plurality of storage devices based on the access.

9. A computer system comprising;
a first server computer;
a second server computer;
a plurality of storage devices having different characteristics, and a storage controller connected to the first server computer and the second server computer via PCI-Express, and connected to the plurality of storage devices,
wherein one of the plurality of storage devices is a nonvolatile memory device,
the storage controller is configured to provide a shared storage area shared by the first server computer and the second server computer, a server computer that is each of the first server computer and the second server computer is configured to store a program that issues an NVM-Express command that is a command conforming to an NVM-Express standard, and
the program is configured to allow the server computer to access the shared storage area via the PCI-Express by issuing the NVM-Express command specifying a namespace associated with the shared storage area, and
the storage controller is configured to place data to be written to the shared storage area in one of the plurality of storage devices based on the access.

10. A computer system comprising;
a first server computer;
a second server computer;
a plurality of storage devices having different characteristics, and a storage controller connected to the first server computer and the second server computer via PCI-Express, and connected to the plurality of storage devices,
wherein one of the plurality of storage devices is a nonvolatile memory device,
the storage controller is configured to provide a first shared storage area and a second shared storage area shared by the first server computer and the second server computer,
a server computer that is each of the first server computer and the second server computer is configured to store a first program that issues an NVM-Express command that is a command conforming to an NVM-Express standard and a second program that issues a particular-standard command that is a command conforming to a particular standard different from the NVM-Express standard,
the first program is configured to allow the server computer to access the first shared storage area via the PCI-Express by issuing the NVM-Express command specifying a namespace associated with the first shared storage area,
the second program is configured to allow the server computer to access the second shared storage area via the PCI-Express by issuing the particular-standard command specifying the second shared storage area,
the storage controller is configured to place data to be written to the first shared storage area in the nonvolatile memory device based on the access via the NVMe command, and
the storage controller is configured to place data to be written to the second shared storage area in one of the plurality of storage devices based on the access via the particular-standard command.
